(19) United States
(12) Patent Application Publication
(10) Pub. No.: US 2026/0230638 A1
(43) Pub. Date: Aug. 6, 2026

(54) POINT CLOUD DATA TRANSMISSION DEVICE, POINT CLOUD DATA TRANSMISSION METHOD, POINT CLOUD DATA RECEPTION DEVICE, AND POINT CLOUD DATA RECEPTION METHOD

(71) Applicant: LG Electronics Inc., Seoul (KR)

(72) Inventors: Alexander ALSHIN, Seoul (KR); Hyejung HUR, Seoul (KR); Vadim SHEPELEV, Seoul (KR); Jongyeul SUH, Seoul (KR)

(21) Appl. No.: 19/146,428

(22) PCT Filed: Jan. 12, 2024
(86) PCT No.: PCT/KR2024/000626

§ 371 Date: Jul. 8, 2025

Related U.S. Application Data
(60) Provisional application No. 63/439,048, filed on Jan. 13, 2023.

(51) Int. Cl. H04N 19/184; H04N 19/13; H04N 19/196; H04N 19/597

(52) U.S. Cl. CPC H04N 19/184; H04N 19/13; H04N 19/198; H04N 19/597

(57) ABSTRACT

A point cloud data transmission method according to embodiments may comprise the steps of: encoding point cloud data; and transmitting a bitstream including the point cloud data. A point cloud data reception method according to embodiments may comprise the steps of: receiving a bitstream including point cloud data; and decoding the point cloud data.

### TECHNICAL FIELD

Embodiments relate to a method and device for processing point cloud content.

### BACKGROUND ART

Point cloud content is content represented by a point cloud, which is a set of points belonging to a coordinate system representing a three-dimensional space. The point cloud content may express media configured in three dimensions, and is used to provide various services such as virtual reality (VR), augmented reality (AR), mixed reality (MR), and self-driving services. However, tens of thousands to hundreds of thousands of point data are required to represent point cloud content. Therefore, there is a need for a method for efficiently processing a large amount of point data.

### DISCLOSURE

### Technical Problem

Embodiments provide a device and method for efficiently processing point cloud data. Embodiments provide a point cloud data processing method and device for addressing latency and encoding/decoding complexity.

The technical scope of the embodiments is not limited to the aforementioned technical objects, and may be extended to other technical objects that may be inferred by those skilled in the art based on the entire contents disclosed herein.

### Technical Solution

In one aspect of the present disclosure, a method of transmitting point cloud data may include encoding point cloud data, and transmitting a bitstream containing the point cloud data. In another aspect of the present disclosure, a method of receiving point cloud data may include receiving a bitstream containing point cloud data, and decoding the point cloud data.

### Advantageous Effects

Devices and methods according to embodiments may process point cloud data with high efficiency.

The devices and methods according to the embodiments may provide a high-quality point cloud service.

The devices and methods according to the embodiments may provide point cloud content for providing general-purpose services such as a VR service and a self-driving service.

### DESCRIPTION OF DRAWINGS

The accompanying drawings, which are included to provide a further understanding of the disclosure and are incorporated in and constitute a part of this application, illustrate embodiment(s) of the disclosure and together with the description serve to explain the principle of the disclosure. For a better understanding of various embodiments described below, reference should be made to the description of the following embodiments in connection with the accompanying drawings. The same reference numbers will be used throughout the drawings to refer to the same or like parts.

FIG. 1 shows an exemplary point cloud content providing system according to embodiments;

FIG. 2 is a block diagram illustrating a point cloud content providing operation according to embodiments;

FIG. 3 illustrates an exemplary point cloud encoder according to embodiments;

FIG. 4 shows an example of an octree and occupancy code according to embodiments;

FIG. 5 illustrates an example of point configuration in each LOD according to embodiments;

FIG. 6 illustrates an example of point configuration in each LOD according to embodiments;

FIG. 7 illustrates a point cloud decoder according to embodiments;

FIG. 8 illustrates a transmission device according to embodiments;

FIG. 9 illustrates a reception device according to embodiments;

FIG. 10 illustrates an exemplary structure operable in connection with point cloud data transmission/reception methods/devices according to embodiments;

FIG. 11 illustrates the change in probability according to the number of updates according to embodiments;

FIG. 12 shows characteristics of entropy coding according to embodiments;

FIG. 13 illustrates the influence of error of probability prediction for compression according to embodiments;

FIG. 14 illustrates the application of probability according to the number of updates according to embodiments;

FIG. 15 illustrates characteristics of parameters of a context model according to embodiments;

FIG. 16 illustrates probability estimation according to embodiments;

FIG. 17 illustrates a probability estimation method according to embodiments;

FIG. 18 illustrates a probability update method according to embodiments;

FIG. 19 illustrates a probability update method according to embodiments;

FIG. 20 illustrates syntax and semantics of probability in context bin decoding according to embodiments;

FIG. 21 illustrates a sequence parameter set (SPS) in a bitstream according to embodiments;

FIG. 22 illustrates a tile parameter set (TPS) in a bitstream according to embodiments;

FIG. 23 illustrates a geometry parameter set (GPS) in a bitstream according to embodiments;

FIG. 24 illustrates a point cloud data transmission device according to embodiments;

FIG. 25 illustrates a point cloud data reception device according to embodiments;

FIG. 26 illustrates a method of decoding context bins for two probability modes according to embodiments;

FIG. 27 illustrates a method of encoding context bins for two probability modes according to embodiments;

FIG. 28 illustrates a method of transmitting point cloud data according to embodiments; and

FIG. 29 illustrates a method of receiving point cloud data according to embodiments.

### BEST MODE

Reference will now be made in detail to the preferred embodiments of the present disclosure, examples of which are illustrated in the accompanying drawings. The detailed description, which will be given below with reference to the accompanying drawings, is intended to explain exemplary embodiments of the present disclosure, rather than to show the only embodiments that may be implemented according to the present disclosure. The following detailed description includes specific details in order to provide a thorough understanding of the present disclosure. However, it will be apparent to those skilled in the art that the present disclosure may be practiced without such specific details.

Although most terms used in the present disclosure have been selected from general ones widely used in the art, some terms have been arbitrarily selected by the applicant and their meanings are explained in detail in the following description as needed. Thus, the present disclosure should be understood based upon the intended meanings of the terms rather than their simple names or meanings.

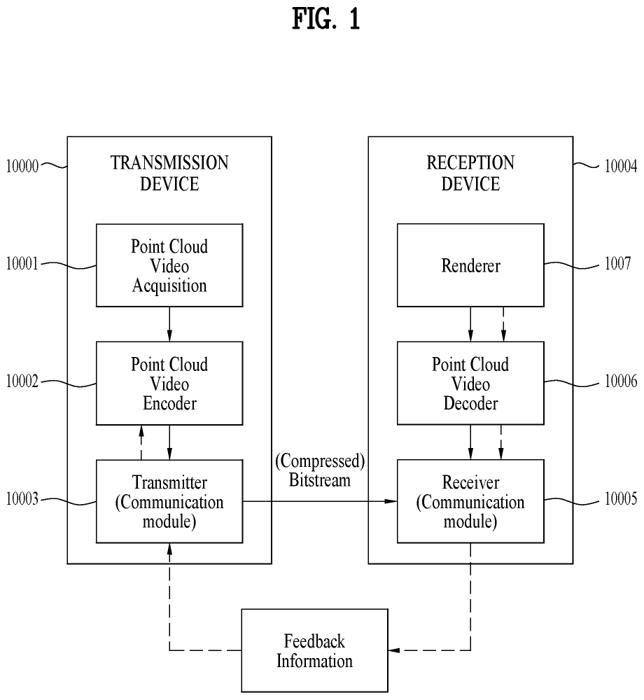

FIG. 1 shows an exemplary point cloud content providing system according to embodiments.

The point cloud content providing system illustrated in FIG. 1 may include a transmission device 10000 and a reception device 10004. The transmission device 10000 and the reception device 10004 are capable of wired or wireless communication to transmit and receive point cloud data.

The point cloud data transmission device 10000 according to the embodiments may secure and process point cloud video (or point cloud content) and transmit the same. According to embodiments, the transmission device 10000 may include a fixed station, a base transceiver system (BTS), a network, an artificial intelligence (AI) device and/or system, a robot, an AR/VR/XR device and/or server. According to embodiments, the transmission device 10000 may include a device, a robot, a vehicle, an AR/VR/XR device, a portable device, a home appliance, an Internet of Thing (IoT) device, and an AI device/server which are configured to perform communication with a base station and/or other wireless devices using a radio access technology (e.g., 5G New RAT (NR), Long Term Evolution (LTE)).

The transmission device 10000 according to the embodiments includes a point cloud video acquirer 10001, a point cloud video encoder 10002, and/or a transmitter (or communication module) 10003.

The point cloud video acquirer 10001 according to the embodiments acquires a point cloud video through a processing process such as capture, synthesis, or generation. The point cloud video is point cloud content represented by a point cloud, which is a set of points positioned in a 3D space, and may be referred to as point cloud video data, point cloud data, or the like. The point cloud video according to the embodiments may include one or more frames. One frame represents a still image/picture. Therefore, the point cloud video may include a point cloud image/frame/picture, and may be referred to as a point cloud image, frame, or picture.

The point cloud video encoder 10002 according to the embodiments encodes the acquired point cloud video data. The point cloud video encoder 10002 may encode the point cloud video data based on point cloud compression coding. The point cloud compression coding according to the embodiments may include geometry-based point cloud compression (G-PCC) coding and/or video-based point cloud compression (V-PCC) coding or next-generation coding. The point cloud compression coding according to the embodiments is not limited to the above-described embodiment. The point cloud video encoder 10002 may output a bitstream containing the encoded point cloud video data. The bitstream may contain not only the encoded point cloud video data, but also signaling information related to encoding of the point cloud video data.

The transmitter 10003 according to the embodiments transmits the bitstream containing the encoded point cloud video data. The bitstream according to the embodiments is encapsulated in a file or segment (e.g., a streaming segment), and is transmitted over various networks such as a broadcasting network and/or a broadband network. Although not shown in the figure, the transmission device 10000 may include an encapsulator (or an encapsulation module) configured to perform an encapsulation operation. According to embodiments, the encapsulator may be included in the transmitter 10003. According to embodiments, the file or segment may be transmitted to the reception device 10004 over a network, or stored in a digital storage medium (e.g., USB, SD, CD, DVD, Blu-ray, HDD, SSD, etc.). The transmitter 10003 according to the embodiments is capable of wired/wireless communication with the reception device 10004 (or the receiver 10005) over a network of 4G, 5G, 6G, etc. In addition, the transmitter may perform a necessary data processing operation according to the network system (e.g., a 4G, 5G or 6G communication network system). The transmission device 10000 may transmit the encapsulated data in an on-demand manner.

The reception device 10004 according to the embodiments includes a receiver 10005, a point cloud video decoder 10006, and/or a renderer 10007. According to embodiments, the reception device 10004 may include a device, a robot, a vehicle, an AR/VR/XR device, a portable device, a home appliance, an Internet of Things (IoT) device, and an AI device/server which are configured to perform communication with a base station and/or other wireless devices using a radio access technology (e.g., 5G New RAT (NR), Long Term Evolution (LTE)).

The receiver 10005 according to the embodiments receives the bitstream containing the point cloud video data or the file/segment in which the bitstream is encapsulated from the network or storage medium. The receiver 10005 may perform necessary data processing according to the network system (e.g., a communication network system of 4G, 5G, 6G, etc.). The receiver 10005 according to the embodiments may decapsulate the received file/segment and output a bitstream. According to embodiments, the receiver 10005 may include a decapsulator (or a decapsulation module) configured to perform a decapsulation operation. The decapsulator may be implemented as an element (or component) separate from the receiver 10005.

The point cloud video decoder 10006 decodes the bitstream containing the point cloud video data. The point cloud video decoder 10006 may decode the point cloud video data according to the method by which the point cloud video data is encoded (e.g., in a reverse process of the operation of the point cloud video encoder 10002). Accordingly, the point cloud video decoder 10006 may decode the point cloud video data by performing point cloud decompression coding, which is the reverse process to the point cloud compression. The point cloud decompression coding includes G-PCC coding.

The renderer 10007 renders the decoded point cloud video data. The renderer 10007 may output point cloud content by rendering not only the point cloud video data but also audio data. According to embodiments, the renderer 10007 may include a display configured to display the point cloud content. According to embodiments, the display may be implemented as a separate device or component rather than being included in the renderer 10007.

The arrows indicated by dotted lines in the drawing represent a transmission path of feedback information acquired by the reception device 10004. The feedback information is information for reflecting interactivity with a user who consumes the point cloud content, and includes information about the user (e.g., head orientation information, viewport information, and the like). In particular, when the point cloud content is content for a service (e.g., self-driving service, etc.) that requires interaction with the user, the feedback information may be provided to the content transmitting side (e.g., the transmission device 10000) and/or the service provider. According to embodiments, the feedback information may be used in the reception device 10004 as well as the transmission device 10000, or may not be provided.

The head orientation information according to embodiments is information about the user's head position, orientation, angle, motion, and the like. The reception device 10004 according to the embodiments may calculate the viewport information based on the head orientation information. The viewport information may be information about a region of a point cloud video that the user is viewing. A viewpoint is a point through which the user is viewing the point cloud video, and may refer to a center point of the viewport region. That is, the viewport is a region centered on the viewpoint, and the size and shape of the region may be determined by a field of view (FOV). Accordingly, the reception device 10004 may extract the viewport information based on a vertical or horizontal FOV supported by the device in addition to the head orientation information. Also, the reception device 10004 performs gaze analysis or the like to check the way the user consumes a point cloud, a region that the user gazes at in the point cloud video, a gaze time, and the like. According to embodiments, the reception device 10004 may transmit feedback information including the result of the gaze analysis to the transmission device 10000. The feedback information according to the embodiments may be acquired in the rendering and/or display process. The feedback information according to the embodiments may be secured by one or more sensors included in the reception device 10004. According to embodiments, the feedback information may be secured by the renderer 10007 or a separate external element (or device, component, or the like). The dotted lines in FIG. 1 represent a process of transmitting the feedback information secured by the renderer 10007. The point cloud content providing system may process (encode/decode) point cloud data based on the feedback information. Accordingly, the point cloud video data decoder 10006 may perform a decoding operation based on the feedback information. The reception device 10004 may transmit the feedback information to the transmission device 10000. The transmission device 10000 (or the point cloud video data encoder 10002) may perform an encoding operation based on the feedback information. Accordingly, the point cloud content providing system may efficiently process necessary data (e.g., point cloud data corresponding to the user's head position) based on the feedback information rather than processing (encoding/decoding) the entire point cloud data, and provide point cloud content to the user.

According to embodiments, the transmission device 10000 may be called an encoder, a transmission device, a transmitter, or the like, and the reception device 10004 may be called a decoder, a receiving device, a receiver, or the like.

The point cloud data processed in the point cloud content providing system of FIG. 1 according to embodiments (through a series of processes of acquisition/encoding/transmission/decoding/rendering) may be referred to as point cloud content data or point cloud video data. According to embodiments, the point cloud content data may be used as a concept covering metadata or signaling information related to the point cloud data.

The elements of the point cloud content providing system illustrated in FIG. 1 may be implemented by hardware, software, a processor, and/or a combination thereof.

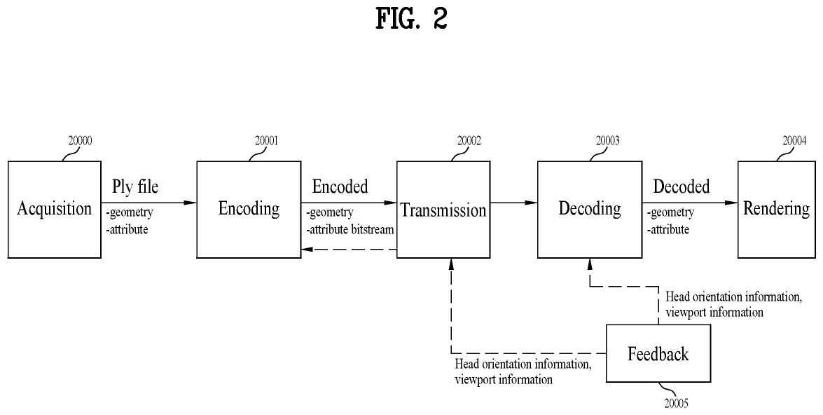

FIG. 2 is a block diagram illustrating a point cloud content providing operation according to embodiments.

The block diagram of FIG. 2 shows the operation of the point cloud content providing system described in FIG. 1. As described above, the point cloud content providing system may process point cloud data based on point cloud compression coding (e.g., G-PCC).

The point cloud content providing system according to the embodiments (e.g., the point cloud transmission device 10000 or the point cloud video acquirer 10001) may acquire a point cloud video (20000). The point cloud video is represented by a point cloud belonging to a coordinate system for expressing a 3D space. The point cloud video according to the embodiments may include a Ply (Polygon File format or the Stanford Triangle format) file. When the point cloud video has one or more frames, the acquired point cloud video may include one or more Ply files. The Ply files contain point cloud data, such as point geometry and/or attributes. The geometry includes positions of points. The position of each point may be represented by parameters (e.g., values of the X, Y, and Z axes) representing a three-dimensional coordinate system (e.g., a coordinate system composed of X, Y and Z axes). The attributes include attributes of points (e.g., information about texture, color (in YCbCr or RGB), reflectance r, transparency, etc. of each point). A point has one or more attributes. For example, a point may have an attribute that is a color, or two attributes that are color and reflectance. According to embodiments, the geometry may be called positions, geometry information, geometry data, position information, position data, or the like, and the attribute may be called attributes, attribute information, attribute data, or the like. The point cloud content providing system (e.g., the point cloud transmission device 10000 or the point cloud video acquirer 10001) may secure point cloud data from information (e.g., depth information, color information, etc.) related to the acquisition process of the point cloud video.

The point cloud content providing system (e.g., the transmission device 10000 or the point cloud video encoder 10002) according to the embodiments may encode the point cloud data (20001). The point cloud content providing system may encode the point cloud data based on point cloud compression coding. As described above, the point cloud data may include the geometry information and attribute information about a point. Accordingly, the point cloud content providing system may perform geometry encoding of encoding the geometry and output a geometry bitstream. The point cloud content providing system may perform attribute encoding of encoding attributes and output an attribute bitstream. According to embodiments, the point cloud content providing system may perform the attribute encoding based on the geometry encoding. The geometry bitstream and the attribute bitstream according to the embodiments may be multiplexed and output as one bitstream. The bitstream according to the embodiments may further contain signaling information related to the geometry encoding and attribute encoding.

The point cloud content providing system (e.g., the transmission device 10000 or the transmitter 10003) according to the embodiments may transmit the encoded point cloud data (20002). As illustrated in FIG. 1, the encoded point cloud data may be represented by a geometry bitstream and an attribute bitstream. In addition, the encoded point cloud data may be transmitted in the form of a bitstream together with signaling information related to encoding of the point cloud data (e.g., signaling information related to the geometry encoding and the attribute encoding). The point cloud content providing system may encapsulate a bitstream that carries the encoded point cloud data and transmit the same in the form of a file or segment.

The point cloud content providing system (e.g., the reception device 10004 or the receiver 10005) according to the embodiments may receive the bitstream containing the encoded point cloud data. In addition, the point cloud content providing system (e.g., the reception device 10004 or the receiver 10005) may demultiplex the bitstream.

The point cloud content providing system (e.g., the reception device 10004 or the point cloud video decoder 10005) may decode the encoded point cloud data (e.g., the geometry bitstream, the attribute bitstream) transmitted in the bitstream. The point cloud content providing system (e.g., the reception device 10004 or the point cloud video decoder 10005) may decode the point cloud video data based on the signaling information related to encoding of the point cloud video data contained in the bitstream. The point cloud content providing system (e.g., the reception device 10004 or the point cloud video decoder 10005) may decode the geometry bitstream to reconstruct the positions (geometry) of points. The point cloud content providing system may reconstruct the attributes of the points by decoding the attribute bitstream based on the reconstructed geometry. The point cloud content providing system (e.g., the reception device 10004 or the point cloud video decoder 10005) may reconstruct the point cloud video based on the positions according to the reconstructed geometry and the decoded attributes.

The point cloud content providing system according to the embodiments (e.g., the reception device 10004 or the renderer 10007) may render the decoded point cloud data (20004). The point cloud content providing system (e.g., the reception device 10004 or the renderer 10007) may render the geometry and attributes decoded through the decoding process, using various rendering methods. Points in the point cloud content may be rendered to a vertex having a certain thickness, a cube having a specific minimum size centered on the corresponding vertex position, or a circle centered on the corresponding vertex position. All or part of the rendered point cloud content is provided to the user through a display (e.g., a VR/AR display, a general display, etc.).

The point cloud content providing system (e.g., the reception device 10004) according to the embodiments may secure feedback information (20005). The point cloud content providing system may encode and/or decode point cloud data based on the feedback information. The feedback information and the operation of the point cloud content providing system according to the embodiments are the same as the feedback information and the operation described with reference to FIG. 1, and thus a detailed description thereof is omitted.

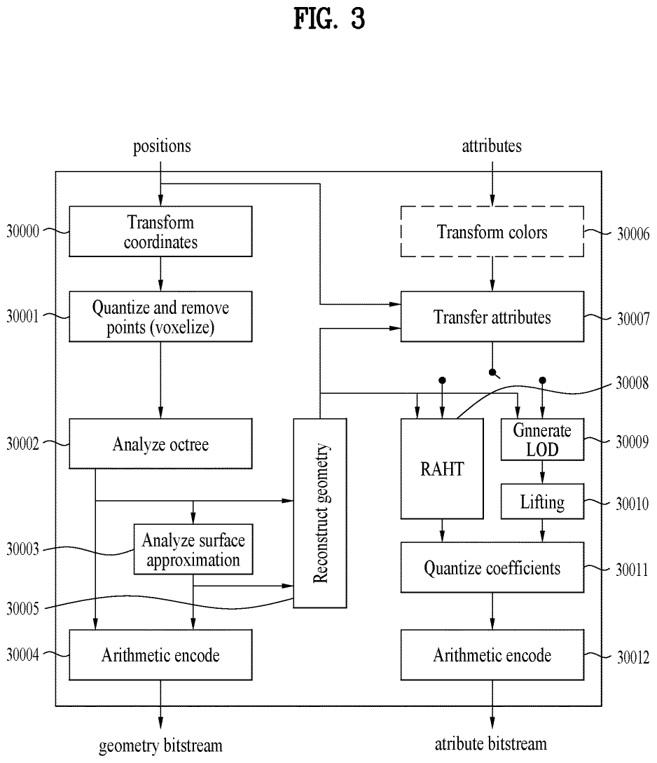

FIG. 3 illustrates an exemplary point cloud encoder according to embodiments.

FIG. 3 shows an example of the point cloud video encoder 10002 of FIG. 1. The point cloud encoder reconstructs and encodes point cloud data (e.g., positions and/or attributes of the points) to adjust the quality of the point cloud content (to, for example, lossless, lossy, or near-lossless) according to the network condition or applications. When the overall size of the point cloud content is large (e.g., point cloud content of 60 Gbps is given for 30 fps), the point cloud content providing system may fail to stream the content in real time. Accordingly, the point cloud content providing system may reconstruct the point cloud content based on the maximum target bitrate to provide the same in accordance with the network environment or the like.

As described with reference to FIGS. 1 and 2, the point cloud encoder may perform geometry encoding and attribute encoding. The geometry encoding is performed before the attribute encoding.

The point cloud encoder according to the embodiments includes a coordinate transformer (Transform coordinates) 30000, a quantizer (Quantize and remove points (voxelize)) 30001, an octree analyzer (Analyze octree) 30002, and a surface approximation analyzer (Analyze surface approximation) 30003, an arithmetic encoder (Arithmetic encode) 30004, a geometry reconstructor (Reconstruct geometry) 30005, a color transformer (Transform colors) 30006, an attribute transformer (Transform attributes) 30007, a RAHT transformer (RAHT) 30008, an LOD generator (Generate LOD) 30009, a lifting transformer (Lifting) 30010, a coefficient quantizer (Quantize coefficients) 30011, and/or an arithmetic encoder (Arithmetic encode) 30012.

The coordinate transformer 30000, the quantizer 30001, the octree analyzer 30002, the surface approximation analyzer 30003, the arithmetic encoder 30004, and the geometry reconstructor 30005 may perform geometry encoding. The geometry encoding according to the embodiments may include octree geometry coding, predictive tree geometry coding, direct coding, trisoup geometry encoding, and entropy encoding. The direct coding and trisoup geometry encoding are applied selectively or in combination. The geometry encoding is not limited to the above-described example.

[33] As shown in the figure, the coordinate transformer 30000 according to the embodiments receives positions and transforms the same into coordinates. For example, the positions may be transformed into position information in a three-dimensional space (e.g., a three-dimensional space represented by an XYZ coordinate system). The position information in the three-dimensional space according to the embodiments may be referred to as geometry information.

The quantizer 30001 according to the embodiments quantizes the geometry. For example, the quantizer 30001 may quantize the points based on a minimum position value of all points (e.g., a minimum value on each of the X, Y, and Z axes). The quantizer 30001 performs a quantization operation of multiplying the difference between the minimum position value and the position value of each point by a preset quantization scale value and then finding the nearest integer value by rounding the value obtained through the multiplication. Thus, one or more points may have the same quantized position (or position value). The quantizer 30001 according to the embodiments performs voxelization based on the quantized positions to reconstruct quantized points. As in the case of a pixel, which is the minimum unit containing 2D image/video information, points of point cloud content (or 3D point cloud video) according to the embodiments may be included in one or more voxels. The term voxel, which is a compound of volume and pixel, refers to a 3D cubic space generated when a 3D space is divided into units (unit=1.0) based on the axes representing the 3D space (e.g., X-axis, Y-axis, and Z-axis). The quantizer 30001 may match groups of points in the 3D space with voxels. According to embodiments, one voxel may include only one point. According to embodiments, one voxel may include one or more points. In order to express one voxel as one point, the position of the center of a voxel may be set based on the positions of one or more points included in the voxel. In this case, attributes of all positions included in one voxel may be combined and assigned to the voxel.

The octree analyzer 30002 according to the embodiments performs octree geometry coding (or octree coding) to present voxels in an octree structure. The octree structure represents points matched with voxels, based on the octal tree structure.

The surface approximation analyzer 30003 according to the embodiments may analyze and approximate the octree. The octree analysis and approximation according to the embodiments is a process of analyzing a region containing a plurality of points to efficiently provide octree and voxelization.

The arithmetic encoder 30004 according to the embodiments performs entropy encoding on the octree and/or the approximated octree. For example, the encoding scheme includes arithmetic encoding. As a result of the encoding, a geometry bitstream is generated.

The color transformer 30006, the attribute transformer 30007, the RAHT transformer 30008, the LOD generator 30009, the lifting transformer 30010, the coefficient quantizer 30011, and/or the arithmetic encoder 30012 perform attribute encoding. As described above, one point may have one or more attributes. The attribute encoding according to the embodiments is equally applied to the attributes that one point has. However, when an attribute (e.g., color) includes one or more elements, attribute encoding is independently applied to each element. The attribute encoding according to the embodiments includes color transform coding, attribute transform coding, region adaptive hierarchical transform (RAHT) coding, interpolation-based hierarchical nearest-neighbor prediction (prediction transform) coding, and interpolation-based hierarchical nearest-neighbor prediction with an update/lifting step (lifting transform) coding. Depending on the point cloud content, the RAHT coding, the prediction transform coding and the lifting transform coding described above may be selectively used, or a combination of one or more of the coding schemes may be used. The attribute encoding according to the embodiments is not limited to the above-described example.

The color transformer 30006 according to the embodiments performs color transform coding of transforming color values (or textures) included in the attributes. For example, the color transformer 30006 may transform the format of color information (for example, from RGB to YCbCr). The operation of the color transformer 30006 according to embodiments may be optionally applied according to the color values included in the attributes.

The geometry reconstructor 30005 according to the embodiments reconstructs (decompresses) the octree and/or the approximated octree. The geometry reconstructor 30005 reconstructs the octree/voxels based on the result of analyzing the distribution of points. The reconstructed octree/voxels may be referred to as reconstructed geometry (restored geometry).

The attribute transformer 30007 according to the embodiments performs attribute transformation to transform the attributes based on the reconstructed geometry and/or the positions on which geometry encoding is not performed. As described above, since the attributes are dependent on the geometry, the attribute transformer 30007 may transform the attributes based on the reconstructed geometry information. For example, based on the position value of a point included in a voxel, the attribute transformer 30007 may transform the attribute of the point at the position. As described above, when the position of the center of a voxel is set based on the positions of one or more points included in the voxel, the attribute transformer 30007 transforms the attributes of the one or more points. When the trisoup geometry encoding is performed, the attribute transformer 30007 may transform the attributes based on the trisoup geometry encoding.

The attribute transformer 30007 may perform the attribute transformation by calculating the average of attributes or attribute values of neighboring points (e.g., color or reflectance of each point) within a specific position/radius from the position (or position value) of the center of each voxel. The attribute transformer 30007 may apply a weight according to the distance from the center to each point in calculating the average. Accordingly, each voxel has a position and a calculated attribute (or attribute value).

The attribute transformer 30007 may search for neighboring points existing within a specific position/radius from the position of the center of each voxel based on the K-D tree or the Morton code. The K-D tree is a binary search tree and supports a data structure capable of managing points based on the positions such that nearest neighbor search (NNS) can be performed quickly. The Morton code is generated by presenting coordinates (e.g., (x, y, z)) representing 3D positions of all points as bit values and mixing the bits. For example, when the coordinates representing the position of a point are (5, 9, 1), the bit values for the coordinates are (0101, 1001, 0001). Mixing the bit values according to the bit index in order of z, y, and x yields 010001000111. This value is expressed as a decimal number of 1095. That is, the Morton code value of the point having coordinates (5, 9, 1) is 1095. The attribute transformer 30007 may order the points based on the Morton code values and perform NNS through a depth-first traversal process. After the attribute transformation operation, the K-D tree or the Morton code is used when the NNS is needed in another transformation process for attribute coding.

As shown in the figure, the transformed attributes are input to the RAHT transformer 40008 and/or the LOD generator 30009.

The RAHT transformer 30008 according to the embodiments performs RAHT coding for predicting attribute information based on the reconstructed geometry information. For example, the RAHT transformer 30008 may predict attribute information of a node at a higher level in the octree based on the attribute information associated with a node at a lower level in the octree.

The LOD generator 30009 according to the embodiments generates a level of detail (LOD) to perform prediction transform coding. The LOD according to the embodiments is a degree of detail of point cloud content. As the LOD value decrease, it indicates that the detail of the point cloud content is degraded. As the LOD value increases, it indicates that the detail of the point cloud content is enhanced. Points may be classified by the LOD.

The lifting transformer 30010 according to the embodiments performs lifting transform coding of transforming the attributes a point cloud based on weights. As described above, lifting transform coding may be optionally applied.

The coefficient quantizer 30011 according to the embodiments quantizes the attribute-coded attributes based on coefficients.

The arithmetic encoder 30012 according to the embodiments encodes the quantized attributes based on arithmetic coding.

Although not shown in the figure, the elements of the point cloud encoder of FIG. 3 may be implemented by hardware including one or more processors or integrated circuits configured to communicate with one or more memories included in the point cloud providing device, software, firmware, or a combination thereof. The one or more processors may perform at least one of the operations and/or functions of the elements of the point cloud encoder of FIG. 3 described above. Additionally, the one or more processors may operate or execute a set of software programs and/or instructions for performing the operations and/or functions of the elements of the point cloud encoder of FIG. 3. The one or more memories according to the embodiments may include a high speed random access memory, or include a non-volatile memory (e.g., one or more magnetic disk storage devices, flash memory devices, or other non-volatile solid-state memory devices).

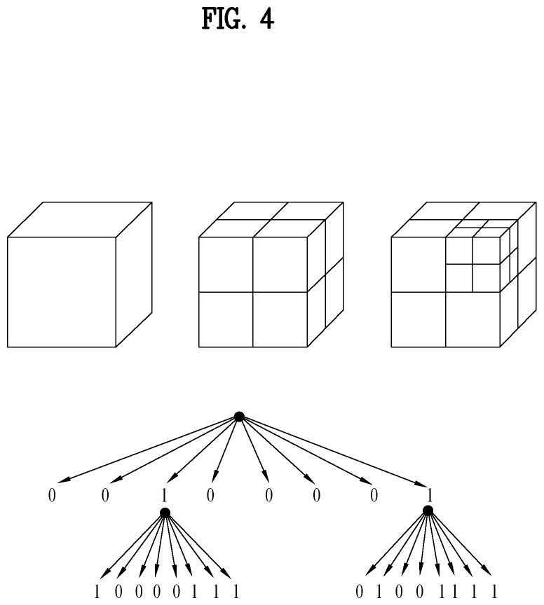

FIG. 4 shows an example of an octree and occupancy code according to embodiments.

As described with reference to FIGS. 1 to 3, the point cloud content providing system (point cloud video encoder 10002) or the point cloud encoder (e.g., the octree analyzer 30002) performs octree geometry coding (or octree coding) based on an octree structure to efficiently manage the region and/or position of the voxel.

The upper part of FIG. 4 shows an octree structure. The 3D space of the point cloud content according to the embodiments is represented by axes (e.g., X-axis, Y-axis, and Z-axis) of the coordinate system. The octree structure is created by recursive subdividing of a cubical axis-aligned bounding box defined by two poles (0, 0, 0) and (2^{d}, 2^{d}, 2^{d}). Here, 2d may be set to a value constituting the smallest bounding box surrounding all points of the point cloud content (or point cloud video). Here, d denotes the depth of the octree. The value of d is determined in the following equation. In the following equation, (x^{int}ₙ, y^{int}ₙ, z^{int}ₙ) denotes the positions (or position values) of quantized points.

$$d = Ceil ( Log 2 ( Max ( {x\_n}^{⋀} int , {y\_n}^{⋀} int , {z\_n}^{⋀} in , n = 1 , … , N ) + 1 ) )$$

As shown in the middle of the upper part of FIG. 4, the entire 3D space may be divided into eight spaces according to partition. Each divided space is represented by a cube with six faces. As shown in the upper right of FIG. 4, each of the eight spaces is divided again based on the axes of the coordinate system (e.g., X-axis, Y-axis, and Z-axis). Accordingly, each space is divided into eight smaller spaces. The divided smaller space is also represented by a cube with six faces. This partitioning scheme is applied until the leaf node of the octree becomes a voxel.

The lower part of FIG. 4 shows an octree occupancy code. The occupancy code of the octree is generated to indicate whether each of the eight divided spaces generated by dividing one space contains at least one point. Accordingly, a single occupancy code is represented by eight child nodes. Each child node represents the occupancy of a divided space, and the child node has a value in 1 bit. Accordingly, the occupancy code is represented as an 8-bit code. That is, when at least one point is contained in the space corresponding to a child node, the node is assigned a value of 1. When no point is contained in the space corresponding to the child node (the space is empty), the node is assigned a value of 0. Since the occupancy code shown in FIG. 4 is 00100001, it indicates that the spaces corresponding to the third child node and the eighth child node among the eight child nodes each contain at least one point. As shown in the figure, each of the third child node and the eighth child node has eight child nodes, and the child nodes are represented by an 8-bit occupancy code. The figure shows that the occupancy code of the third child node is 10000111, and the occupancy code of the eighth child node is 01001111. The point cloud encoder (e.g., the arithmetic encoder 30004) according to the embodiments may perform entropy encoding on the occupancy codes. In order to increase the compression efficiency, the point cloud encoder may perform intra/inter-coding on the occupancy codes. The reception device (e.g., the reception device 10004 or the point cloud video decoder 10006) according to the embodiments reconstructs the octree based on the occupancy codes.

The point cloud encoder (e.g., the point cloud encoder of FIG. 4 or the octree analyzer 30002) according to the embodiments may perform voxelization and octree coding to store the positions of points. However, points are not always evenly distributed in the 3D space, and accordingly there may be a specific region in which fewer points are present. Accordingly, it is inefficient to perform voxelization for the entire 3D space. For example, when a specific region contains few points, voxelization does not need to be performed in the specific region.

Accordingly, for the above-described specific region (or a node other than the leaf node of the octree), the point cloud encoder according to the embodiments may skip voxelization and perform direct coding to directly code the positions of points included in the specific region. The coordinates of a direct coding point according to the embodiments are referred to as direct coding mode (DCM). The point cloud encoder according to the embodiments may also perform trisoup geometry encoding, which is to reconstruct the positions of the points in the specific region (or node) based on voxels, based on a surface model. The trisoup geometry encoding is geometry encoding that represents an object as a series of triangular meshes. Accordingly, the point cloud decoder may generate a point cloud from the mesh surface. The direct coding and trisoup geometry encoding according to the embodiments may be selectively performed. In addition, the direct coding and trisoup geometry encoding according to the embodiments may be performed in combination with octree geometry coding (or octree coding).

To perform direct coding, the option to use the direct mode for applying direct coding should be activated. A node to which direct coding is to be applied is not a leaf node, and points less than a threshold should be present within a specific node. In addition, the total number of points to which direct coding is to be applied should not exceed a preset threshold. When the conditions above are satisfied, the point cloud encoder (or the arithmetic encoder 30004) according to the embodiments may perform entropy coding on the positions (or position values) of the points.

The point cloud encoder (e.g., the surface approximation analyzer 30003) according to the embodiments may determine a specific level of the octree (a level less than the depth d of the octree), and the surface model may be used staring with that level to perform trisoup geometry encoding to reconstruct the positions of points in the region of the node based on voxels (Trisoup mode). The point cloud encoder according to the embodiments may specify a level at which trisoup geometry encoding is to be applied. For example, when the specific level is equal to the depth of the octree, the point cloud encoder does not operate in the trisoup mode. In other words, the point cloud encoder according to the embodiments may operate in the trisoup mode only when the specified level is less than the value of depth of the octree. The 3D cube region of the nodes at the specified level according to the embodiments is called a block. One block may include one or more voxels. The block or voxel may correspond to a brick. Geometry is represented as a surface within each block. The surface according to embodiments may intersect with each edge of a block at most once.

One block has 12 edges, and accordingly there are at least 12 intersections in one block. Each intersection is called a vertex (or apex). A vertex present along an edge is detected when there is at least one occupied voxel adjacent to the edge among all blocks sharing the edge. The occupied voxel according to the embodiments refers to a voxel containing a point. The position of the vertex detected along the edge is the average position along the edge of all voxels adjacent to the edge among all blocks sharing the edge.

Once the vertex is detected, the point cloud encoder according to the embodiments may perform entropy encoding on the starting point (x, y, z) of the edge, the direction vector (Δx, Ay, Δz) of the edge, and the vertex position value (relative position value within the edge). When the trisoup geometry encoding is applied, the point cloud encoder according to the embodiments (e.g., the geometry reconstructor 30005) may generate restored geometry (reconstructed geometry) by performing the triangle reconstruction, up-sampling, and voxelization processes.

The vertices positioned at the edge of the block determine a surface that passes through the block. The surface according to the embodiments is a non-planar polygon. In the triangle reconstruction process, a surface represented by a triangle is reconstructed based on the starting point of the edge, the direction vector of the edge, and the position values of the vertices. The triangle reconstruction process is performed by: i) calculating the centroid value of each vertex, ii) subtracting the center value from each vertex value, and iii) estimating the sum of the squares of the values obtained by the subtraction.

$$* [ \begin{matrix}{μ}_{x} \\ {μ}_{y} \\ {μ}_{z}\end{matrix} ] = \frac{1}{n} {\sum }_{i = 1}^{n} [ \begin{matrix}{x}_{i} \\ {y}_{i} \\ {z}_{i}\end{matrix} ] * [ \begin{matrix}{\overline{x}}_{i} \\ {\overline{y}}_{i} \\ {\overline{z}}_{i}\end{matrix} ] = [ \begin{matrix}{x}_{i} \\ {y}_{i} \\ {z}_{i}\end{matrix} ] - [ \begin{matrix}{μ}_{x} \\ {μ}_{y} \\ {μ}_{z}\end{matrix} ] * [ \begin{matrix}{σ}_{x}^{2} \\ {σ}_{y}^{2} \\ {σ}_{z}^{2}\end{matrix} ] = {\sum }_{i = 1}^{n} [ \begin{matrix}{\overline{x}}_{i}^{2} \\ {\overline{y}}_{i}^{2} \\ {\overline{z}}_{i}^{2}\end{matrix} ]$$

The minimum value of the sum is estimated, and the projection process is performed according to the axis with the minimum value. For example, when the element x is the minimum, each vertex is projected on the x-axis with respect to the center of the block, and projected on the (y, z) plane. When the values obtained through projection on the (y, z) plane are (ai, bi), the value of θ is estimated through a tan 2(bi, ai), and the vertices are ordered based on the value of θ. The table below shows a combination of vertices for creating a triangle according to the number of the vertices. The vertices are ordered from 1 to n. The table below shows that for four vertices, two triangles may be constructed according to combinations of vertices. The first triangle may consist of vertices 1, 2, and 3 among the ordered vertices, and the second triangle may consist of vertices 3, 4, and 1 among the ordered vertices.

TABLE 2-1
Triangles formed from vertices ordered 1, . . . , n

| n | triangles |
|---|---|
| 3 | (1, 2, 3) |
| 4 | (1, 2, 3), (3, 4, 1) |
| 5 | (1, 2, 3), (3, 4, 5), (5, 1, 3) |
| 6 | (1, 2, 3), (3, 4, 5), (5, 6, 1), (1, 3, 5) |
| 7 | (1, 2, 3), (3, 4, 5), (5, 6, 7), (7, 1, 3), (3, 5, 7) |
| 8 | (1, 2, 3), (3, 4, 5), (5, 6, 7), (7, 8, 1), (1, 3, 5), (5, 7, 1) |
| 9 | (1, 2, 3), (3, 4, 5), (5, 6, 7), (7, 8, 9), (9, 1, 3), (3, 5, 7), (7, 9, 3) |
| 10 | (1, 2, 3), (3, 4, 5), (5, 6, 7), (7, 8, 9), (9, 10, 1), (1, 3, 5), (5, 7, 9), (9, 1, 5) |
| 11 | (1, 2, 3), (3, 4, 5), (5, 6, 7), (7, 8, 9), (9, 10, 11), (11, 1, 3), (3, 5, 7), (7, 9, 11), (11, 3, 7) |
| 12 | (1, 2, 3), (3, 4, 5), (5, 6, 7), (7, 8, 9), (9, 10, 11), (11, 12, 1), (1, 3, 5), (5, 7, 9), (9, 11, 1), (1, 5, 9) |

The upsampling process is performed to add points in the middle along the edge of the triangle and perform voxelization. The added points are generated based on the upsampling factor and the width of the block. The added points are called refined vertices. The point cloud encoder according to the embodiments may voxelize the refined vertices. In addition, the point cloud encoder may perform attribute encoding based on the voxelized positions (or position values).

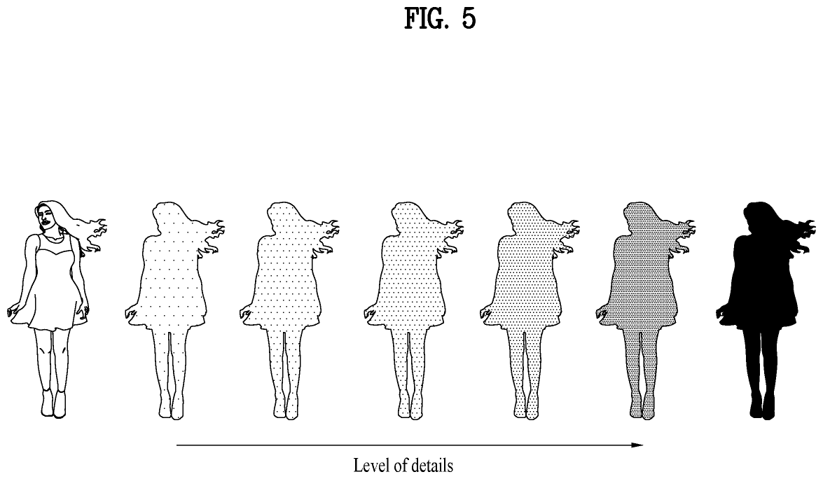

FIG. 5 illustrates an example of point configuration in each LOD according to embodiments.

As described with reference to FIGS. 1 to 4, encoded geometry is reconstructed (decompressed) before attribute encoding is performed. When direct coding is applied, the geometry reconstruction operation may include changing the placement of direct coded points (e.g., placing the direct coded points in front of the point cloud data). When trisoup geometry encoding is applied, the geometry reconstruction process is performed through triangle reconstruction, up-sampling, and voxelization. Since the attribute depends on the geometry, attribute encoding is performed based on the reconstructed geometry.

The point cloud encoder (e.g., the LOD generator 30009) may classify (or reorganize) points by LOD. The figure shows the point cloud content corresponding to LODs. The leftmost picture in the figure represents original point cloud content. The second picture from the left of the figure represents distribution of the points in the lowest LOD, and the rightmost picture in the figure represents distribution of the points in the highest LOD. That is, the points in the lowest LOD are sparsely distributed, and the points in the highest LOD are densely distributed. That is, as the LOD rises in the direction pointed by the arrow indicated at the bottom of the figure, the space (or distance) between points is narrowed.

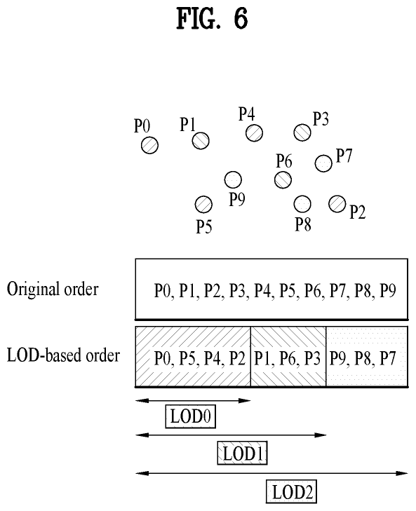

FIG. 6 illustrates an example of point configuration for each LOD according to embodiments.

As described with reference to FIGS. 1 to 5, the point cloud content providing system, or the point cloud encoder (e.g., the point cloud video encoder 10002, the point cloud encoder of FIG. 3, or the LOD generator 30009) may generates an LOD. The LOD is generated by reorganizing the points into a set of refinement levels according to a set LOD distance value (or a set of Euclidean distances). The LOD generation process is performed not only by the point cloud encoder, but also by the point cloud decoder.

The upper part of FIG. 6 shows examples (P0 to P9) of points of the point cloud content distributed in a 3D space. In FIG. 6, the original order represents the order of points P0 to P9 before LOD generation. In FIG. 6, the LOD based order represents the order of points according to the LOD generation. Points are reorganized by LOD. Also, a high LOD contains the points belonging to lower LODs. As shown in FIG. 6, LOD0 contains P0, P5, P4 and P2. LOD1 contains the points of LOD0, P1, P6 and P3. LOD2 contains the points of LOD0, the points of LOD1, P9, P8 and P7.

As described with reference to FIG. 3, the point cloud encoder according to the embodiments may perform prediction transform coding, lifting transform coding, and RAHT transform coding selectively or in combination.

The point cloud encoder according to the embodiments may generate a predictor for points to perform prediction transform coding for setting a predicted attribute (or predicted attribute value) of each point. That is, N predictors may be generated for N points. The predictor according to the embodiments may calculate a weight (=1/distance) based on the LOD value of each point, indexing information about neighboring points present within a set distance for each LOD, and a distance to the neighboring points.

The predicted attribute (or attribute value) according to the embodiments is set to the average of values obtained by multiplying the attributes (or attribute values) (e.g., color, reflectance, etc.) of neighbor points set in the predictor of each point by a weight (or weight value) calculated based on the distance to each neighbor point. The point cloud encoder according to the embodiments (e.g., the coefficient quantizer 30011) may quantize and inversely quantize the residuals (which may be called residual attributes, residual attribute values, or attribute prediction residuals, attribute residuals) obtained by subtracting a predicted attribute (attribute value) from the attribute (attribute value) of each point. The quantization process is configured as shown in the following table.

TABLE Attribute prediction residuals quantization pseudo code
int PCCQuantization(int value, int quantStep) {
if( value >=0) {
return floor(value / quantStep + 1.0 / 3.0);
} else {
return −floor(−value / quantStep + 1.0 / 3.0);
}
}
TABLE Attribute prediction residuals inverse quantization pseudo code
int PCCInverseQuantization(int value, int quantStep) {
if( quantStep == 0) {
return value;
} else {
return value * quantStep;
}
}

When the predictor of each point has neighbor points, the point cloud encoder (e.g., the arithmetic encoder 30012) according to the embodiments may perform entropy coding on the quantized and inversely quantized residual values as described above. When the predictor of each point has no neighbor point, the point cloud encoder according to the embodiments (e.g., the arithmetic encoder 30012) may perform entropy coding on the attributes of the corresponding point without performing the above-described operation.

The point cloud encoder according to the embodiments (e.g., the lifting transformer 30010) may generate a predictor of each point, set the calculated LOD and register neighbor points in the predictor, and set weights according to the distances to neighbor points to perform lifting transform coding. The lifting transform coding according to the embodiments is similar to the above-described prediction transform coding, but differs therefrom in that weights are cumulatively applied to attribute values. The process of cumulatively applying weights to the attribute values according to embodiments is configured as follows.

1) Create an array Quantization Weight (QW) for storing the weight value of each point. The initial value of all elements of QW is 1.0. Multiply the QW values of the predictor indexes of the neighbor nodes registered in the predictor by the weight of the predictor of the current point, and add the values obtained by the multiplication.

2) Lift prediction process: Subtract the value obtained by multiplying the attribute value of the point by the weight from the existing attribute value to calculate a predicted attribute value.

3) Create temporary arrays called updateweight and update and initialize the temporary arrays to zero.

4) Cumulatively add the weights calculated by multiplying the weights calculated for all predictors by a weight stored in the QW corresponding to a predictor index to the updateweight array as indexes of neighbor nodes. Cumulatively add, to the update array, a value obtained by multiplying the attribute value of the index of a neighbor node by the calculated weight.

5) Lift update process: Divide the attribute values of the update array for all predictors by the weight value of the updateweight array of the predictor index, and add the existing attribute value to the values obtained by the division.

6) Calculate predicted attributes by multiplying the attribute values updated through the lift update process by the weight updated through the lift prediction process (stored in the QW) for all predictors. The point cloud encoder (e.g., coefficient quantizer 30011) according to the embodiments quantizes the predicted attribute values. In addition, the point cloud encoder (e.g., the arithmetic encoder 30012) performs entropy coding on the quantized attribute values.

The point cloud encoder (for example, the RAHT transformer 30008) according to the embodiments may perform RAHT transform coding in which attributes of nodes of a higher level are predicted using the attributes associated with nodes of a lower level in the octree. RAHT transform coding is an example of attribute intra coding through an octree backward scan. The point cloud encoder according to the embodiments scans the entire region from the voxel and repeats the merging process of merging the voxels into a larger block at each step until the root node is reached. The merging process according to the embodiments is performed only on the occupied nodes. The merging process is not performed on the empty node. The merging process is performed on an upper node immediately above the empty node.

The equation below represents a RAHT transformation matrix. In the equation, gₗ_{_{x,y,z}} denotes the average attribute value of voxels at level l. gₗ_{_{x,y,z}} may be calculated based on gₗ₊₁_{_{2x,y,z}} and gₗ₊₁_{_{2x+1,y,z}}. The weights for gₗ_{_{2x,y,z}} and gₗ_{_{2x+1,y,z}} are w1=wₗ _{_{2x,y,z}} and w2=wₗ_{_{2x+1,y,z}}.

$$⌈ \begin{matrix}{g}_{l - {1}_{x , y , z}} \\ {h}_{l - {1}_{x , y , z}}\end{matrix} ⌉ = {T}_{w 1 w 2} ⌈ \begin{matrix}{g}_{{l}_{2 x , y , z}} \\ {h}_{{l}_{2 x + 1 , y , z}}\end{matrix} ⌉ , {T}_{w 1 w 2} = \frac{1}{\sqrt{w 1 + w 2}} [ \begin{matrix}\sqrt{w 1} & - \sqrt{w 2} \\ - \sqrt{w 2} & \sqrt{w 1}\end{matrix} ]$$

Here, gₗ₋₁ _{_{x,y,z}} is a low-pass value and is used in the merging process at the next higher level.

$${h}_{l - {1}_{x , y , z}}$$

denotes high-pass coefficients. The high-pass coefficients at each step are quantized and subjected to entropy coding (e.g., encoding by the arithmetic encoder 300012). The weights are calculated as wₗ_{_{−1 x,y,z}}=wₗ_{_{2x, y,z}}+wₗ_{_{2x+1,y,z}}. The root node is created through the g₁ _{_{0,0,0}} and g₁ _{_{0,0,1}} as follows.

$$⌈ \begin{matrix}gDC \\ {h}_{{0}_{0 , 0 , 0}}\end{matrix} ⌉ = {T}_{w 1000 w 1001} ⌈ \begin{matrix}{g}_{{1}_{0 , 0 , 0 z}} \\ {g}_{{1}_{0 , 0 , 1}}\end{matrix} ⌉$$

The value of gDC is also quantized and subjected to entropy coding like the high-pass coefficients.

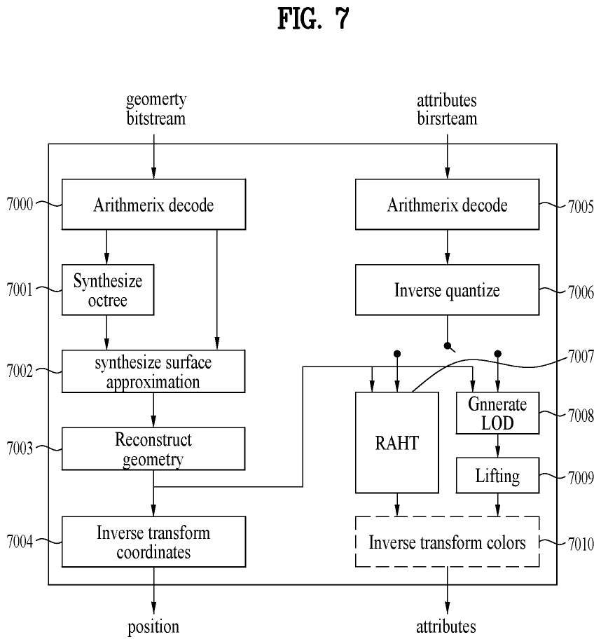

FIG. 7 illustrates a point cloud decoder according to embodiments.

The point cloud decoder illustrated in FIG. 7 is an example of the point cloud decoder and may perform a decoding operation, which is a reverse process to the encoding operation of the point cloud encoder illustrated in FIGS. 1 to 6.

As described with reference to FIGS. 1 and 6, the point cloud decoder may perform geometry decoding and attribute decoding. The geometry decoding is performed before the attribute decoding.

The point cloud decoder according to the embodiments includes an arithmetic decoder (Arithmetic decode) 7000, an octree synthesizer (Synthesize octree) 7001, a surface approximation synthesizer (Synthesize surface approximation) 7002, and a geometry reconstructor (Reconstruct geometry) 7003, a coordinate inverse transformer (Inverse transform coordinates) 7004, an arithmetic decoder (Arithmetic decode) 7005, an inverse quantizer (Inverse quantize) 7006, a RAHT transformer 7007, an LOD generator (Generate LOD) 7008, an inverse lifter (inverse lifting) 7009, and/or a color inverse transformer (Inverse transform colors) 7010.

The arithmetic decoder 7000, the octree synthesizer 7001, the surface approximation synthesizer 7002, and the geometry reconstructor 7003, and the coordinate inverse transformer 7004 may perform geometry decoding. The geometry decoding according to the embodiments may include direct decoding and trisoup geometry decoding. The direct coding and trisoup geometry decoding are selectively applied. The geometry decoding is not limited to the above-described example, and is performed as a reverse process to the geometry encoding described with reference to FIGS. 1 to 6.

The arithmetic decoder 7000 according to the embodiments decodes the received geometry bitstream based on the arithmetic coding. The operation of the arithmetic decoder 7000 corresponds to the reverse process to the arithmetic encoder 30004.

The octree synthesizer 7001 according to the embodiments may generate an octree by acquiring an occupancy code from the decoded geometry bitstream (or information on the geometry secured as a result of decoding). The occupancy code is configured as described in detail with reference to FIGS. 1 to 6.

When the trisoup geometry encoding is applied, the surface approximation synthesizer 7002 according to the embodiments may synthesize a surface based on the decoded geometry and/or the generated octree.

The geometry reconstructor 7003 according to the embodiments may regenerate geometry based on the surface and/or the decoded geometry. As described with reference to FIGS. 1 to 9, direct coding and trisoup geometry encoding are selectively applied. Accordingly, the geometry reconstructor 7003 directly imports and adds position information about the points to which direct coding is applied. When the trisoup geometry encoding is applied, the geometry reconstructor 7003 may reconstruct the geometry by performing the reconstruction operations of the geometry reconstructor 30005, for example, triangle reconstruction, up-sampling, and voxelization. Details are the same as those described with reference to FIG. 6, and thus description thereof is omitted. The reconstructed geometry may include a point cloud picture or frame that does not contain attributes.

The coordinate inverse transformer 7004 according to the embodiments may acquire positions of the points by transforming the coordinates based on the reconstructed geometry.

The arithmetic decoder 7005, the inverse quantizer 7006, the RAHT transformer 7007, the LOD generator 7008, the inverse lifter 7009, and/or the color inverse transformer 7010 may perform the attribute decoding described with reference to FIG. 6. The attribute decoding according to the embodiments includes region adaptive hierarchical transform (RAHT) decoding, interpolation-based hierarchical nearest-neighbor prediction (prediction transform) decoding, and interpolation-based hierarchical nearest-neighbor prediction with an update/lifting step (lifting transform) decoding. The three decoding schemes described above may be used selectively, or a combination of one or more decoding schemes may be used. The attribute decoding according to the embodiments is not limited to the above-described example.

The arithmetic decoder 7005 according to the embodiments decodes the attribute bitstream by arithmetic coding.

The inverse quantizer 7006 according to the embodiments inversely quantizes the information about the decoded attribute bitstream or attributes secured as a result of the decoding, and outputs the inversely quantized attributes (or attribute values). The inverse quantization may be selectively applied based on the attribute encoding of the point cloud encoder.

According to embodiments, the RAHT transformer 7007, the LOD generator 7008, and/or the inverse lifter 7009 may process the reconstructed geometry and the inversely quantized attributes. As described above, the RAHT transformer 7007, the LOD generator 7008, and/or the inverse lifter 7009 may selectively perform a decoding operation corresponding to the encoding of the point cloud encoder.

The color inverse transformer 7010 according to the embodiments performs inverse transform coding to inversely transform a color value (or texture) included in the decoded attributes. The operation of the color inverse transformer 7010 may be selectively performed based on the operation of the color transformer 30006 of the point cloud encoder.

Although not shown in the figure, the elements of the point cloud decoder of FIG. 7 may be implemented by hardware including one or more processors or integrated circuits configured to communicate with one or more memories included in the point cloud providing device, software, firmware, or a combination thereof. The one or more processors may perform at least one or more of the operations and/or functions of the elements of the point cloud decoder of FIG. 7 described above. Additionally, the one or more processors may operate or execute a set of software programs and/or instructions for performing the operations and/or functions of the elements of the point cloud decoder of FIG. 7.

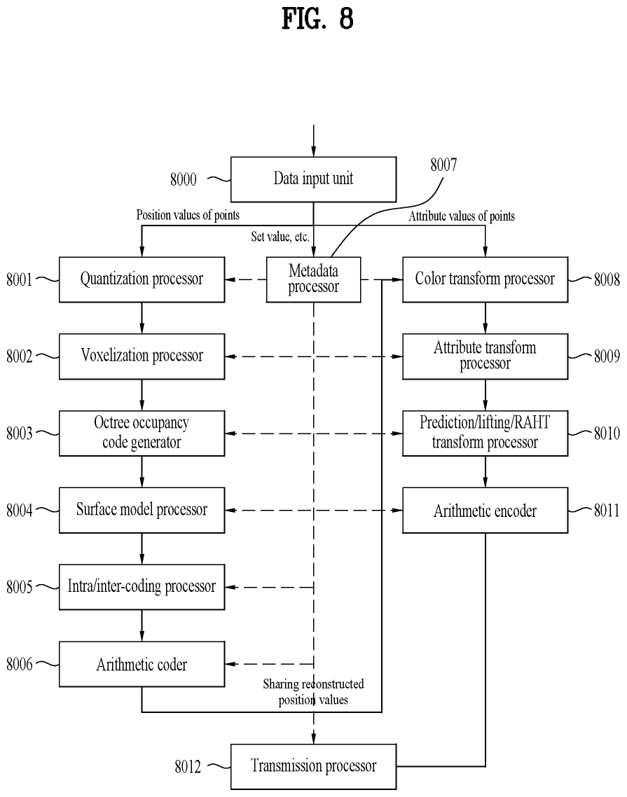

FIG. 8 illustrates a transmission device according to embodiments.

The transmission device shown in FIG. 8 is an example of the transmission device 10000 of FIG. 1 (or the point cloud encoder of FIG. 3). The transmission device illustrated in FIG. 8 may perform one or more of the operations and methods the same as or similar to those of the point cloud encoder described with reference to FIGS. 1 to 6. The transmission device according to the embodiments may include a data input unit 8000, a quantization processor 8001, a voxelization processor 8002, an octree occupancy code generator 8003, a surface model processor 8004, an intra/inter-coding processor 8005, an arithmetic coder 8006, a metadata processor 8007, a color transform processor 8008, an attribute transform processor 8009, a prediction/lifting/RAHT transform processor 8010, an arithmetic coder 8011 and/or a transmission processor 8012.

The data input unit 8000 according to the embodiments receives or acquires point cloud data. The data input unit 8000 may perform an operation and/or acquisition method the same as or similar to the operation and/or acquisition method of the point cloud video acquirer 10001 (or the acquisition process 20000 described with reference to FIG. 2).

The data input unit 8000, the quantization processor 8001, the voxelization processor 8002, the octree occupancy code generator 8003, the surface model processor 8004, the intra/inter-coding processor 8005, and the arithmetic coder 8006 perform geometry encoding. The geometry encoding according to the embodiments is the same as or similar to the geometry encoding described with reference to FIGS. 1 to 9, and thus a detailed description thereof is omitted.

The quantization processor 8001 according to the embodiments quantizes geometry (e.g., position values of points). The operation and/or quantization of the quantization processor 8001 is the same as or similar to the operation and/or quantization of the quantizer 30001 described with reference to FIG. 3. Details are the same as those described with reference to FIGS. 1 to 9.

The voxelization processor 8002 according to the embodiments voxelizes the quantized position values of the points. The voxelization processor 8002 may perform an operation and/or process the same or similar to the operation and/or the voxelization process of the quantizer 30001 described with reference to FIG. 3. Details are the same as those described with reference to FIGS. 1 to 6.

The octree occupancy code generator 8003 according to the embodiments performs octree coding on the voxelized positions of the points based on an octree structure. The octree occupancy code generator 8003 may generate an occupancy code. The octree occupancy code generator 8003 may perform an operation and/or method the same as or similar to the operation and/or method of the point cloud encoder (or the octree analyzer 30002) described with reference to FIGS. 3 and 4. Details are the same as those described with reference to FIGS. 1 to 6.

The surface model processor 8004 according to the embodiments may perform trisoup geometry encoding based on a surface model to reconstruct the positions of points in a specific region (or node) on a voxel basis. The surface model processor 8004 may perform an operation and/or method the same as or similar to the operation and/or method of the point cloud encoder (e.g., the surface approximation analyzer 30003) described with reference to FIG. 3. Details are the same as those described with reference to FIGS. 1 to 6.

The intra/inter-coding processor 8005 according to the embodiments may perform intra/inter-coding on point cloud data. The intra/inter-coding processor 8005 may perform coding the same as or similar to the intra/inter-coding described with reference to FIG. 7. Details are the same as those described with reference to FIG. 7. According to embodiments, the intra/inter-coding processor 8005 may be included in the arithmetic coder 8006.

The arithmetic coder 8006 according to the embodiments performs entropy encoding on an octree of the point cloud data and/or an approximated octree. For example, the encoding scheme includes arithmetic encoding. The arithmetic coder 8006 performs an operation and/or method the same as or similar to the operation and/or method of the arithmetic encoder 30004.

The metadata processor 8007 according to the embodiments processes metadata about the point cloud data, for example, a set value, and provides the same to a necessary processing process such as geometry encoding and/or attribute encoding. Also, the metadata processor 8007 according to the embodiments may generate and/or process signaling information related to the geometry encoding and/or the attribute encoding. The signaling information according to the embodiments may be encoded separately from the geometry encoding and/or the attribute encoding. The signaling information according to the embodiments may be interleaved.

The color transform processor 8008, the attribute transform processor 8009, the prediction/lifting/RAHT transform processor 8010, and the arithmetic coder 8011 perform the attribute encoding. The attribute encoding according to the embodiments is the same as or similar to the attribute encoding described with reference to FIGS. 1 to 6, and thus a detailed description thereof is omitted.

The color transform processor 8008 according to the embodiments performs color transform coding to transform color values included in attributes. The color transform processor 8008 may perform color transform coding based on the reconstructed geometry. The reconstructed geometry is the same as described with reference to FIGS. 1 to 9. Also, it performs an operation and/or method the same as or similar to the operation and/or method of the color transformer 30006 described with reference to FIG. 3 is performed. A detailed description thereof is omitted.

The attribute transform processor 8009 according to the embodiments performs attribute transformation to transform the attributes based on the reconstructed geometry and/or the positions on which geometry encoding is not performed. The attribute transform processor 8009 performs an operation and/or method the same as or similar to the operation and/or method of the attribute transformer 30007 described with reference to FIG. 3. A detailed description thereof is omitted. The prediction/lifting/RAHT transform processor 8010 according to the embodiments may code the transformed attributes by any one or a combination of RAHT coding, prediction transform coding, and lifting transform coding. The prediction/lifting/RAHT transform processor 8010 performs at least one of the operations the same as or similar to the operations of the RAHT transformer 30008, the LOD generator 30009, and the lifting transformer 30010 described with reference to FIG. 3. In addition, the prediction transform coding, the lifting transform coding, and the RAHT transform coding are the same as those described with reference to FIGS. 1 to 9, and thus a detailed description thereof is omitted.

The arithmetic coder 8011 according to the embodiments may encode the coded attributes based on the arithmetic coding. The arithmetic coder 8011 performs an operation and/or method the same as or similar to the operation and/or method of the arithmetic encoder 300012.

The transmission processor 8012 according to the embodiments may transmit each bitstream containing encoded geometry and/or encoded attributes and metadata information, or transmit one bitstream configured with the encoded geometry and/or the encoded attributes and the metadata information. When the encoded geometry and/or the encoded attributes and the metadata information according to the embodiments are configured into one bitstream, the bitstream may include one or more sub-bitstreams. The bitstream according to the embodiments may contain signaling information including a sequence parameter set (SPS) for signaling of a sequence level, a geometry parameter set (GPS) for signaling of geometry information coding, an attribute parameter set (APS) for signaling of attribute information coding, and a tile parameter set (TPS) for signaling of a tile level, and slice data. The slice data may include information about one or more slices. One slice according to embodiments may include one geometry bitstream Geom00 and one or more attribute bitstreams Attr00 and Attr10.

A slice refers to a series of syntax elements representing the entirety or part of a coded point cloud frame.

The TPS according to the embodiments may include information about each tile (e.g., coordinate information and height/size information about a bounding box) for one or more tiles. The geometry bitstream may contain a header and a payload. The header of the geometry bitstream according to the embodiments may contain a parameter set identifier (geom_parameter_set_id), a tile identifier (geom_tile_id) and a slice identifier (geom_slice_id) included in the GPS, and information about the data contained in the payload. As described above, the metadata processor 8007 according to the embodiments may generate and/or process the signaling information and transmit the same to the transmission processor 8012. According to embodiments, the elements to perform geometry encoding and the elements to perform attribute encoding may share data/information with each other as indicated by dotted lines. The transmission processor 8012 according to the embodiments may perform an operation and/or transmission method the same as or similar to the operation and/or transmission method of the transmitter 10003. Details are the same as those described with reference to FIGS. 1 and 2, and thus a description thereof is omitted.

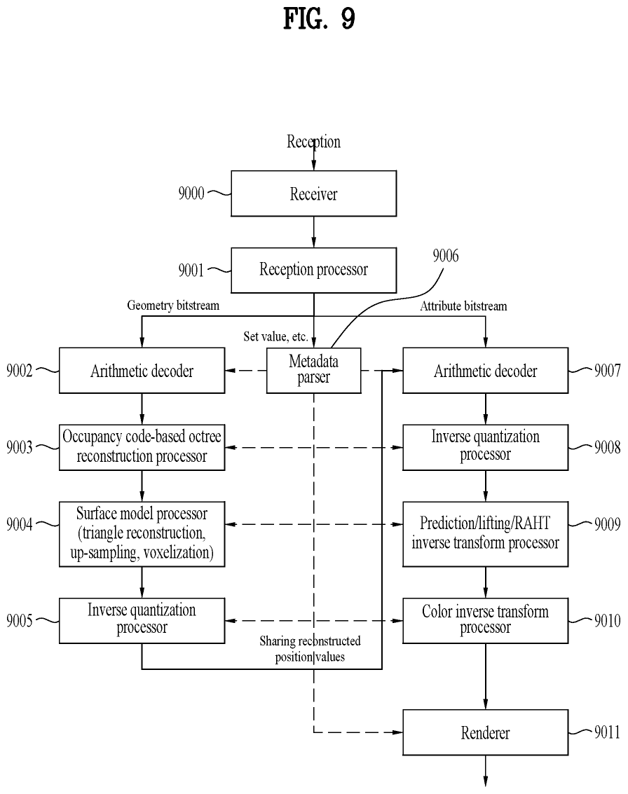

FIG. 9 illustrates a reception device according to embodiments.

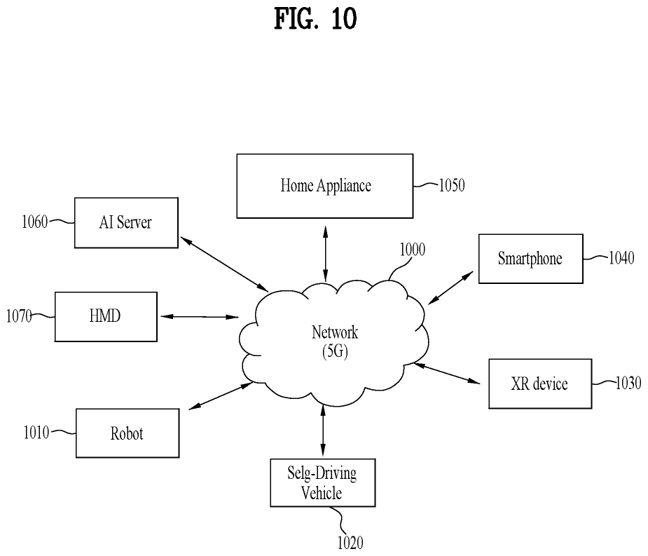

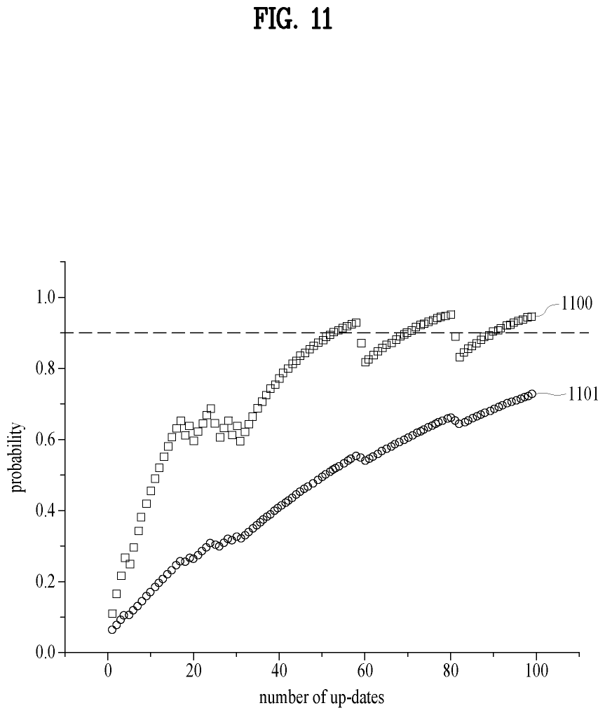

The reception device illustrated in FIG. 9 is an example of the reception device 10004 of FIG. 1 (or the point cloud decoder of FIGS. 10 and 11). The reception device illustrated in FIG. 9 may perform one or more of the operations and methods the same as or similar to those of the point cloud decoder described with reference to FIGS. 1 to 11.

The reception device according to the embodiment may include a receiver 9000, a reception processor 9001, an arithmetic decoder 9002, an occupancy code-based octree reconstruction processor 9003, a surface model processor (triangle reconstruction, up-sampling, voxelization) 9004, an inverse quantization processor 9005, a metadata parser 9006, an arithmetic decoder 9007, an inverse quantization processor 9008, a prediction/lifting/RAHT inverse transform processor 9009, a color inverse transform processor 9010, and/or a renderer 9011. Each element for decoding according to the embodiments may perform a reverse process to the operation of a corresponding element for encoding according to the embodiments.

The receiver 9000 according to the embodiments receives point cloud data. The receiver 9000 may perform an operation and/or reception method the same as or similar to the operation and/or reception method of the receiver 10005 of FIG. 1. The detailed description thereof is omitted.

The reception processor 9001 according to the embodiments may acquire a geometry bitstream and/or an attribute bitstream from the received data. The reception processor 9001 may be included in the receiver 9000.

The arithmetic decoder 9002, the occupancy code-based octree reconstruction processor 9003, the surface model processor 9004, and the inverse quantization processor 905 may perform geometry decoding. The geometry decoding according to embodiments is the same as or similar to the geometry decoding described with reference to FIGS. 1 to 10, and thus a detailed description thereof is omitted.

The arithmetic decoder 9002 according to the embodiments may decode the geometry bitstream based on arithmetic coding. The arithmetic decoder 9002 performs an operation and/or coding the same as or similar to the operation and/or coding of the arithmetic decoder 7000.

The occupancy code-based octree reconstruction processor 9003 according to the embodiments may reconstruct an octree by acquiring an occupancy code from the decoded geometry bitstream (or information about the geometry secured as a result of decoding). The occupancy code-based octree reconstruction processor 9003 performs an operation and/or method the same as or similar to the operation and/or octree generation method of the octree synthesizer 7001. When the trisoup geometry encoding is applied, the surface model processor 9004 according to the embodiments may perform trisoup geometry decoding and related geometry reconstruction (e.g., triangle reconstruction, up-sampling, voxelization) based on the surface model method. The surface model processor 9004 performs an operation the same as or similar to that of the surface approximation synthesizer 7002 and/or the geometry reconstructor 7003.

The inverse quantization processor 9005 according to the embodiments may inversely quantize the decoded geometry.

The metadata parser 9006 according to the embodiments may parse metadata contained in the received point cloud data, for example, a set value. The metadata parser 9006 may pass the metadata to geometry decoding and/or attribute decoding. The metadata is the same as that described with reference to FIG. 8, and thus a detailed description thereof is omitted.

The arithmetic decoder 9007, the inverse quantization processor 9008, the prediction/lifting/RAHT inverse transform processor 9009 and the color inverse transform processor 9010 perform attribute decoding. The attribute decoding is the same as or similar to the attribute decoding described with reference to FIGS. 1 to 10, and thus a detailed description thereof is omitted.

The arithmetic decoder 9007 according to the embodiments may decode the attribute bitstream by arithmetic coding. The arithmetic decoder 9007 may decode the attribute bitstream based on the reconstructed geometry. The arithmetic decoder 9007 performs an operation and/or coding the same as or similar to the operation and/or coding of the arithmetic decoder 7005.

The inverse quantization processor 9008 according to the embodiments may inversely quantize the decoded attribute bitstream. The inverse quantization processor 9008 performs an operation and/or method the same as or similar to the operation and/or inverse quantization method of the inverse quantizer 7006.

The prediction/lifting/RAHT inverse transform processor 9009 according to the embodiments may process the reconstructed geometry and the inversely quantized attributes. The prediction/lifting/RAHT inverse transform processor 9009 performs one or more of operations and/or decoding the same as or similar to the operations and/or decoding of the RAHT transformer 7007, the LOD generator 7008, and/or the inverse lifter 7009. The color inverse transform processor 9010 according to the embodiments performs inverse transform coding to inversely transform color values (or textures) included in the decoded attributes. The color inverse transform processor 9010 performs an operation and/or inverse transform coding the same as or similar to the operation and/or inverse transform coding of the color inverse transformer 7010. The renderer 9011 according to the embodiments may render the point cloud data.

FIG. 10 illustrates an exemplary structure operable in connection with point cloud data transmission/reception methods/devices according to embodiments.

The structure of FIG. 10 represents a configuration in which at least one of a server 1060, a robot 1010, a self-driving vehicle 1020, an XR device 1030, a smartphone 1040, a home appliance 1050, and/or a head-mount display (HMD) 1070 is connected to the cloud network 1000. The robot 1010, the self-driving vehicle 1020, the XR device 1030, the smartphone 1040, or the home appliance 1050 is called a device. Further, the XR device 1030 may correspond to a point cloud data (PCC) device according to embodiments or may be operatively connected to the PCC device.

The cloud network 1000 may represent a network that constitutes part of the cloud computing infrastructure or is present in the cloud computing infrastructure. Here, the cloud network 1000 may be configured using a 3G network, 4G or Long Term Evolution (LTE) network, or a 5G network.

The server 1060 may be connected to at least one of the robot 1010, the self-driving vehicle 1020, the XR device 1030, the smartphone 1040, the home appliance 1050, and/or the HMD 1070 over the cloud network 1000 and may assist in at least a part of the processing of the connected devices 1010 to 1070.

The HMD 1070 represents one of the implementation types of the XR device and/or the PCC device according to the embodiments. The HMD type device according to the embodiments includes a communication unit, a control unit, a memory, an I/O unit, a sensor unit, and a power supply unit.

Hereinafter, various embodiments of the devices 1010 to 1050 to which the above-described technology is applied will be described. The devices 1010 to 1050 illustrated in FIG. 10 may be operatively connected/coupled to a point cloud data transmission device and reception device according to the above-described embodiments.

### <PCC+XR>

The XR/PCC device 1030 may employ PCC technology and/or XR (AR+VR) technology, and may be implemented as an HMD, a head-up display (HUD) provided in a vehicle, a television, a mobile phone, a smartphone, a computer, a wearable device, a home appliance, a digital signage, a vehicle, a stationary robot, or a mobile robot.

The XR/PCC device 1030 may analyze 3D point cloud data or image data acquired through various sensors or from an external device and generate position data and attribute data about 3D points. Thereby, the XR/PCC device 1030 may acquire information about the surrounding space or a real object, and render and output an XR object. For example, the XR/PCC device 1030 may match an XR object including auxiliary information about a recognized object with the recognized object and output the matched XR object.

### <PCC+XR+Mobile Phone>

The XR/PCC device 1030 may be implemented as a mobile phone 1040 by applying PCC technology.

The mobile phone 1040 may decode and display point cloud content based on the PCC technology.

### <PCC+Self-Driving+XR>

The self-driving vehicle 1020 may be implemented as a mobile robot, a vehicle, an unmanned aerial vehicle, or the like by applying the PCC technology and the XR technology.

The self-driving vehicle 1020 to which the XR/PCC technology is applied may represent a self-driving vehicle provided with means for providing an XR image, or a self-driving vehicle that is a target of control/interaction in the XR image. In particular, the self-driving vehicle 1020 which is a target of control/interaction in the XR image may be distinguished from the XR device 1030 and may be operatively connected thereto.

The self-driving vehicle 1020 having means for providing an XR/PCC image may acquire sensor information from sensors including a camera, and output the generated XR/PCC image based on the acquired sensor information. For example, the self-driving vehicle 1020 may have an HUD and output an XR/PCC image thereto, thereby providing an occupant with an XR/PCC object corresponding to a real object or an object present on the screen.

When the XR/PCC object is output to the HUD, at least a part of the XR/PCC object may be output to overlap the real object to which the occupant's eyes are directed. On the other hand, when the XR/PCC object is output on a display provided inside the self-driving vehicle, at least a part of the XR/PCC object may be output to overlap an object on the screen. For example, the self-driving vehicle 1220 may output XR/PCC objects corresponding to objects such as a road, another vehicle, a traffic light, a traffic sign, a two-wheeled vehicle, a pedestrian, and a building.

The virtual reality (VR) technology, the augmented reality (AR) technology, the mixed reality (MR) technology and/or the point cloud compression (PCC) technology according to the embodiments are applicable to various devices.

In other words, the VR technology is a display technology that provides only CG images of real-world objects, backgrounds, and the like. On the other hand, the AR technology refers to a technology that shows a virtually created CG image on the image of a real object. The MR technology is similar to the AR technology described above in that virtual objects to be shown are mixed and combined with the real world. However, the MR technology differs from the AR technology in that the AR technology makes a clear distinction between a real object and a virtual object created as a CG image and uses virtual objects as complementary objects for real objects, whereas the MR technology treats virtual objects as objects having equivalent characteristics as real objects. More specifically, an example of MR technology applications is a hologram service.

Recently, the VR, AR, and MR technologies are sometimes referred to as extended reality (XR) technology rather than being clearly distinguished from each other. Accordingly, embodiments of the present disclosure are applicable to any of the VR, AR, MR, and XR technologies. The encoding/decoding based on PCC, V-PCC, and G-PCC techniques is applicable to such technologies.

The PCC method/device according to the embodiments may be applied to a vehicle that provides a self-driving service.

A vehicle that provides the self-driving service is connected to a PCC device for wired/wireless communication.

When the point cloud data (PCC) transmission/reception device according to the embodiments is connected to a vehicle for wired/wireless communication, the device may receive/process content data related to an AR/VR/PCC service, which may be provided together with the self-driving service, and transmit the same to the vehicle. In the case where the PCC transmission/reception device is mounted on a vehicle, the PCC transmission/reception device may receive/process content data related to the AR/VR/PCC service according to a user input signal input through a user interface device and provide the same to the user. The vehicle or the user interface device according to the embodiments may receive a user input signal. The user input signal according to the embodiments may include a signal indicating the self-driving service.

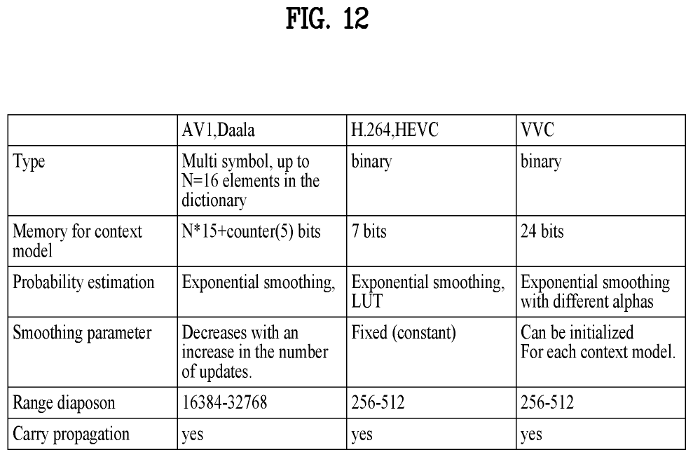

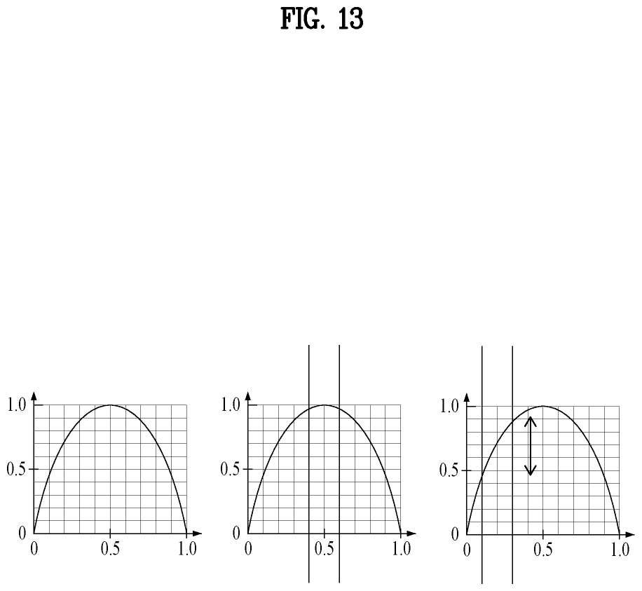

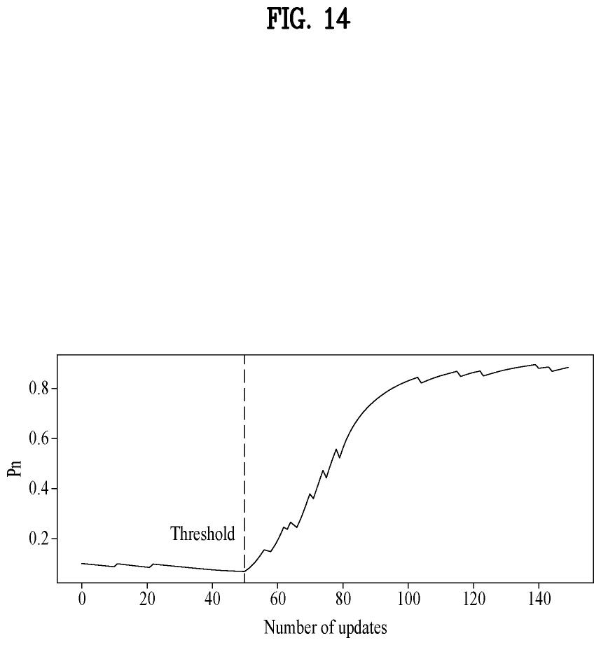

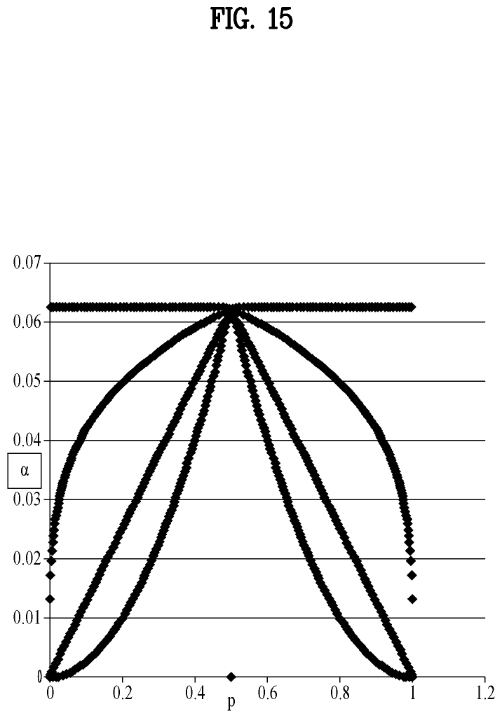

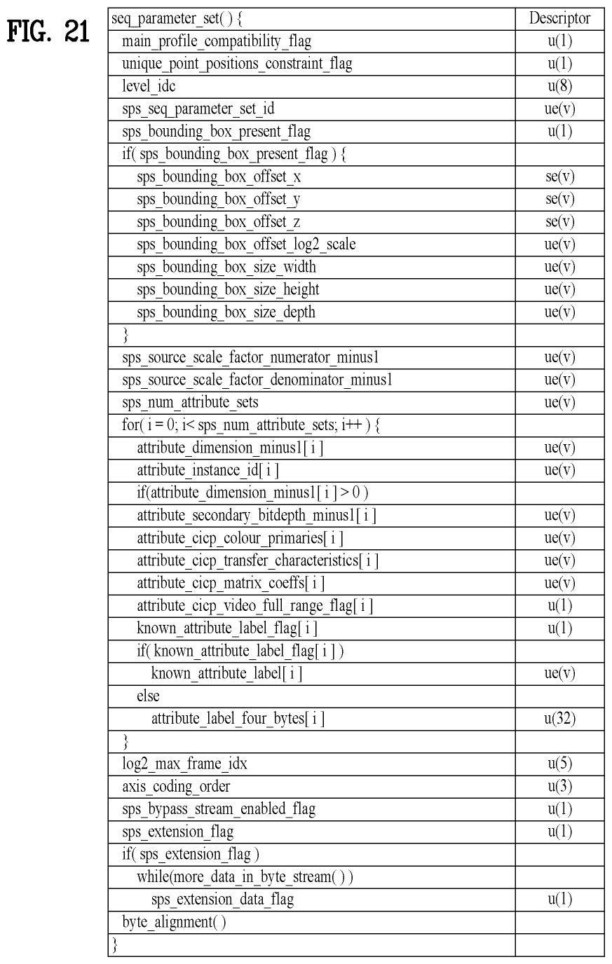

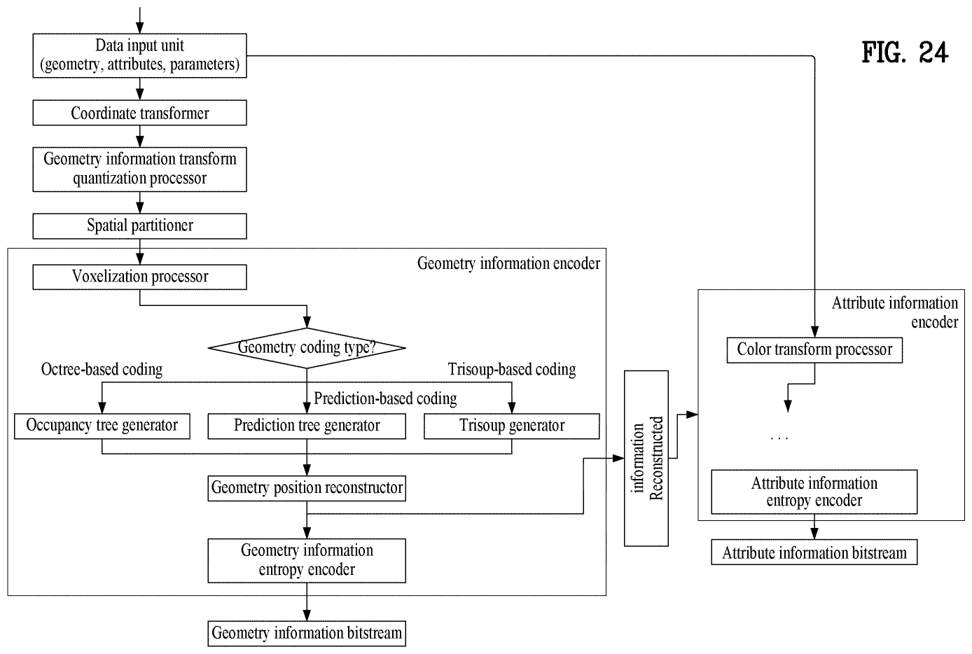

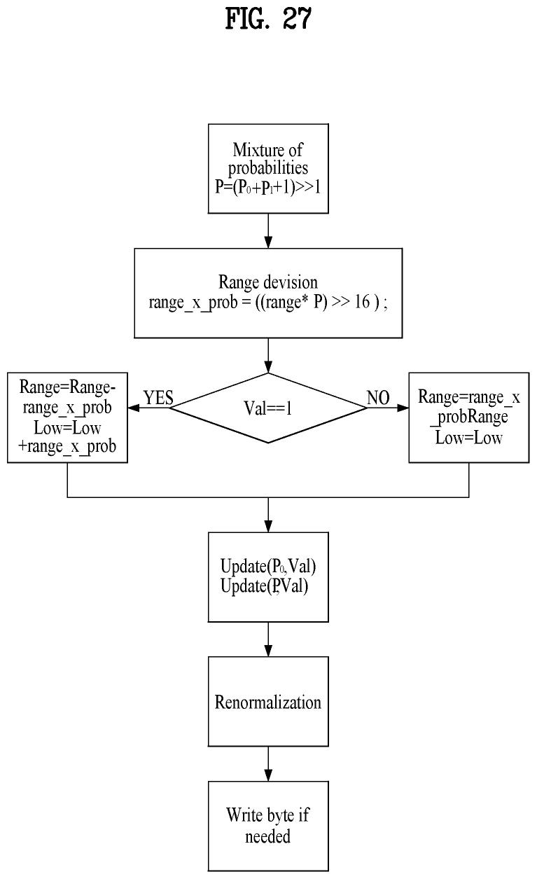

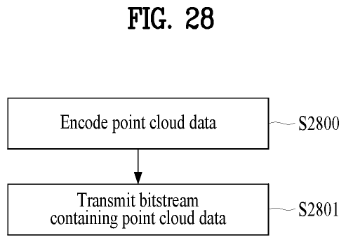

The point cloud data transmission method/device according to embodiments is interpreted as the transmission device 10000, the point cloud video encoder 10002, the transmitter 10003 in FIG. 1, the acquisition 20000/encoding 20001/transmission 20002 in FIG. 2, the encoder in FIG. 3, the transmission device in FIG. 8, the devices in FIG. 10, the probability update in FIG. 11; the entropy coding in FIG. 12; the probability estimation in FIG. 13; the probability application in FIG. 14; probability estimation in FIGS. 15 to 20, the bitstream and parameter generation in FIGS. 21 to 23, the transmission device (encoder) in FIG. 24, the context bin encoding in FIG. 27, the transmission method in FIG. 28, and the like.

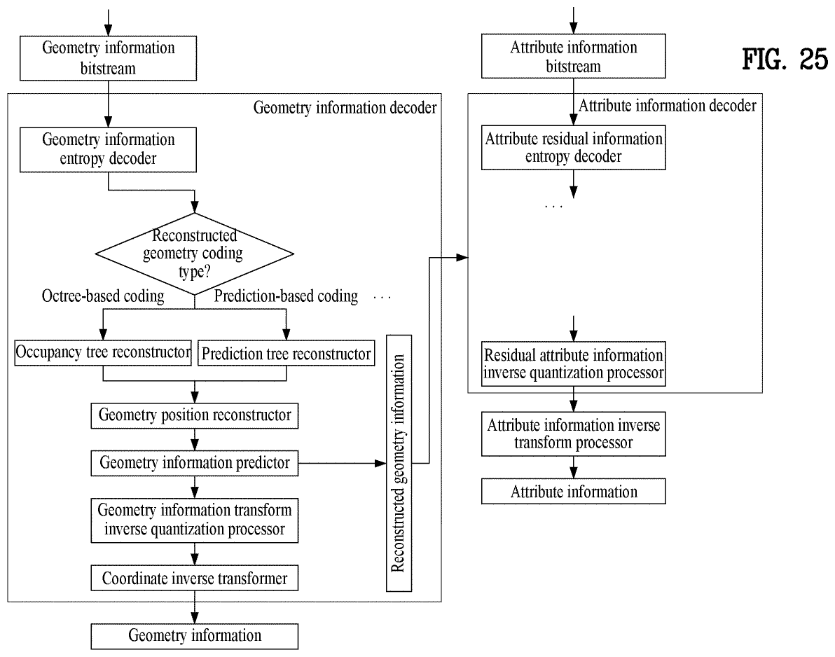

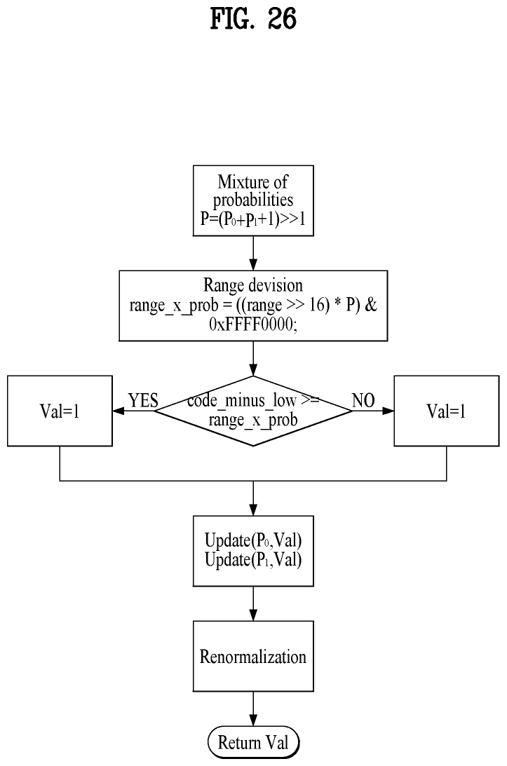

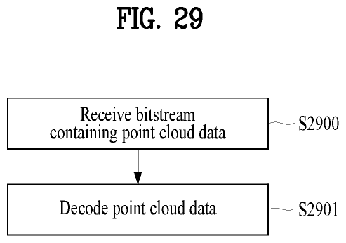

The point cloud data reception method/device according to embodiments is interpreted as a term referring to the transmission device 10000, the point cloud video encoder 10002, the transmitter 10003 in FIG. 1, the acquisition 20000/encoding 20001/transmission 20002 in FIG. 2, the encoder in FIG. 3, the transmission device in FIG. 8, the devices in FIG. 10, the probability update in FIG. 11, the entropy coding in FIG. 12, the probability estimation in FIG. 13, the probability application in FIG. 14, the probability estimation in FIGS. 15 to 20, the bitstream and parameter parsing in FIGS. 21 to 23, the reception device (decoder) in FIG. 25, the context bin decoding in FIG. 26, the reception method in FIG. 29, and the like.

Further, the point cloud data transmission/reception method/device according to the embodiments may be referred to simply as a method/device.

According to embodiments, geometry data, geometry information, position information, and geometry constituting point cloud data are to be construed as having the same meaning. Attribute data and attribute information constituting the point cloud data are to be construed as having the same meaning.

The method/device according to the embodiments includes and performs a method for improving probability estimation of context bins for encoding and decoding of G-PCC files.

Embodiments describe methods for improving probability estimation for context bins of Geometry-based Point Cloud Compression (G-PCC) files. The methods are written based on the ISO-based media file format for the carriage of G-PCC.

Embodiments relate to a transmitter or receiver for providing point cloud content services that efficiently stores a G-PCC bitstream within a single track in a file and provides signaling for the same.

Embodiments relate to a transmitter or receiver for providing point cloud content services that handles file storage techniques to support efficient access to the stored G-PCC bitstream.

Embodiments include a method of partitioning and storing the G-PCC bitstream into one or more tracks in a file, in addition to (or by additionally modifying/combining) file storage techniques for supporting efficient storage of G-PCC bitstreams within a track in a file and signaling thereof, and efficient access to stored G-PCC bitstreams.

Embodiments are described with reference to, for example, ISO/IEC 23090-18 Carriage of Geometry-based Point Cloud Compression Data and/or ISO/IEC 23090-18 Carriage of Geometry-based Point Cloud Compression Data-Amendment 1: Support of Temporal Scalability.

PCC data may be transmitted and received in the ISO-based media file format (ISOBMF). To support effective entropy codding in a G-PCC file, the G-PCC bitstream may be written using the bypass or context mode. For the processing of context bins, the encoder and decoder determine the probability on the fly, and therefore high-precision probability estimation is very important. The current implementation of probability estimation in TMC13 consists of a one-parameter estimation model which is approximated by a lookup table. However, for accurate probability estimation, multi-parameter models are often more effective. For example, for VVC standard, a two-parameter model with constant parameters is used to handle random sources with positive autocorrelation. It is important to maintain a fast speed of adoption and high precision for probability estimation.

Embodiments include a new approach for probability estimation in which several nonlinear estimators are calculated independently and a mixture of them is used for the final estimation. Every estimator has nonlinear dependence governing parameters from probability. Thus, a balance may be kept between the speed of adaptation and the accuracy.

The definitions of terms according to embodiments are given below.

Point cloud frame: A set of 3D points specified by Cartesian coordinates (x, y, z), and optionally a fixed set of corresponding attributes at a particular time instance.

Bounding box: A rectangular cuboid in which the source point cloud frame is included.

Geometry: A set of Cartesian coordinates associated with a point cloud frame

Attribute: A scalar or vector property optionally associated with each point in a point cloud, such as color, reflectance, frame index, etc.

APS: Attribute Parameter Set, ASH: Attribute Slice Header, GSH: Geometry Slice Header, GPS: Geometry Parameter Set, LSB: Least Significant Bit, RAHT: Regional Adaptive Hierarchical Transform, SPS: Sequence Parameter Set, TPS: Tile Parameter Set, which is the same as tile inventory, Slice: A series of syntax elements representing a part of or entire coded point cloud frame, 3D Tile: A rectangular cuboid inside a bounding box.

For the first time, R. V. LHartley in 1928 for the alphabet with equiprobable symbols and finally C. Shannon [3] in 1948 found a theoretical limit for the compression of the message when probabilities of symbols are known in advance. According Shannon's source coding theorem, the expected code length cannot be less than the so-called entropy of the source.

$$I ( x ) = - {\sum }_{i = 1}^{N} {p}_{i} {log}_{2} {p}_{i}$$

The alphabet consists of N elements and pᵢ is the probability of each symbol. Suppose probability is known in advance. There are several algorithms such as Huffman codes, arithmetic coding, PIPE, etc., that can perform close to the Shannon limit. In modern codecs, it is necessary to deal with a huge amount of different data, the stream of symbols (bins) is a mixture of streams of different sources, and each of the streams has a different probability distribution of the occurrence of a particular symbol. This allows the introduction of context dependence, that is, already encoded symbols. The probability is replaced by a conditional probability. The data that need to be encoded are distributed among context models-groups of syntactic elements with similar statistical characteristics. The probabilities are estimated within each model independently. However, in most situations, probability is not known and should be estimated on the fly. Moreover, probabilities may change during encoding. That is why the construction of high-precision probability estimation with the possibility of adaptation is one of the common ways to improve entropy coding. The majority of modern coding schemes use a so-called exponential coding technique for probability estimation. For binary sources, it is represented as:

$$\hat{p} = α y + ( 1 - α ) p$$

Where y is a current symbol that may be equal to “1” or “0,” p is an old probability estimation, \hat{p} is a new probability estimation. This formula was proposed in 1957 and is well-used. For example, probability estimation in H.264/AVC (High Profile) and H.265/HEVC is performed using a lookup table derived from this formula when α=1/19.6. This idea is also used for H.266/VVC. However, alpha is the power of two, α=½^{k}, which means that multiplication may be substituted by shifting. For a source with constant probability p, the expected value of the exponential smoothing estimator is equal to p, which means that this is an unbiased estimator. The variance of this estimator in the case when the source is uncorrelated is:

$$E [ {( p ( t ) - p )}^{2} ] = \frac{α}{2 - α} ( p - {p}^{2} )$$

During the development of VVC standard statistical properties of each context, models were studied in detail. In particular, it was found that the assumption that the source is uncorrelated is incorrect and the majority of context models have positive autocorrelation. Further, it was shown that the two-parameter estimator provides better results than the conventional one-parameter estimator for a wide range of correlation coefficients. That is why in VVC two estimations with different alphas are calculated simultaneously and the half sum is used for the final estimation. For Daala and AV1, video coding format multi-symbol entropy codecs are used with dictionary size less or equal to 16. It is necessary to update up to 15 cumulative probabilities in each context model. It is carried out using an exponential smoothing technique with α=½^{k}. The parameter α is responsible for the sensitivity of the model. If alpha (parameter) is big, the model will quickly react to any changes and probability estimation converges to an optimal value very fast. Only a few previously encoded bins have a significant influence on current probability estimation. If alpha is small, the number of previously encoded bins which has a significant influence on probability estimation increases estimation and becomes more robust.

FIG. 11 illustrates the change in probability according to the number of updates according to embodiments.

FIG. 11 shows the probability prediction results according to the value of the parameter α described above.

1100 depicts the change in probability according to the number of updates when the parameter is 1/16, and 1101 depicts the change in probability according to the number of updates when the parameter is 1/128. It can be seen that as the value of the parameter increases, the probability saturation occurs more rapidly with the number of updates.

FIG. 12 shows characteristics of entropy coding according to embodiments.

FIG. 12 presents types, memory requirements for context models, probability estimation techniques, smoothing parameters, and the like according to AV1, Daala, H.264, HEVC, and VVC standards.

To apply the neural network approach for image compression (e.g., JPEG AI), it is necessary to use multi-symbol entropy coding with a huge dictionary size (>512). In this case, updating for each cumulative probability is labor-consuming. Instead, it is effective to use global distribution approximation. The decoder needs to know only a few parameters to start decoding the bitstream (e.g., μ, σ2 mean value and variance).

Regarding the non-linear dependence smoothing parameter from probability, according to the Shannon formula, the average number of bits per bin cannot be less than the so-called Shannon limit. In the binary case, it may be written as:

$$S = - p {log}_{2} p - ( 1 - p ) {log}_{2} ( 1 - p )$$

where p determines the likelihood of the next binary symbol having the value 1.

FIG. 13 illustrates the influence of error of probability prediction for compression according to embodiments.

FIG. 13 depicts the influence of error of probability prediction for compression.

When the bin's probability is close to 0.5, even a noticeable error in probability estimation does not lead to significant changes in the number of bits. However, if the error occurs when the probability is close to 1 or 0, it may dramatically change the compression ratio. It is desirable to have a mechanism capable of reducing estimation error when the probability is close to 0 or 1. As parameter α is a base determining the rate of adaptation, a may be varied depending on probability. Thus, when alpha is close to 0 when the probability is 0 or 1, the estimation error will be low, and the new probability equal 0.5 error does not significantly affect the number of bits. And alpha may be increased to accelerate adaptation to the optimal value. Thus, the sharp change in statistics will lead to the fast adaptation of probability estimation.

FIG. 14 illustrates the application of probability according to the number of updates according to embodiments.

FIG. 14 illustrates an example of probability adaptation after the sharp change in statistics.

Combining the idea of two estimator and nonlinear dependence smoothing parameters from probabilities following the model may be represented as:

$$\text{?} = {α}_{0} ( p ) y + ( 1 - {α}_{0} ( p ) ) {p}_{0}$$

$$\text{?} = {α}_{1} ( p ) y + ( 1 - {α}_{1} ( p ) ) {p}_{1}$$

$$\hat{p} = ( \text{?} + \text{?} ) / 2$$

where

$${α}_{k} ( p ) = {{β}_{k} ( \frac{p}{0.5} )}^{{n}_{k}}$$

for p∈= [0,0.5] and αₖ(p)=αₖ(1−p) for pe [0.5,1]. The numbers βₖ and nₖ are configurable parameters of the model. Note that when nₖ=0, αₖ(p)=βₖ is a constant value for all possible p.

FIG. 15 illustrates characteristics of parameters of a context model according to embodiments.

FIG. 15 illustrates the dependence of α(p) for n=0, ¼, 1, 2.

The obvious advantage of such a model is the possibility to control the error of probability estimation and rate of probability adaptation depending on the probability value. On the contrary, the estimation may become unbiased, especially for a source with autocorrelation, that is, a statistical relationship between sequences of values of the same series, taken with a shift of time. On the other hand, it is important to reduce the error of probability estimation, especially near probability values close to 0 and 1.

Initialization. For the exponential smoothing model, the value N=1/α determines the number of previously encoded bins that have a significant influence on probability estimation. This value is also called a window size. The model with a short window size quickly converges to an optimal value of probability while the model with a long window size (smaller alpha) requires a significant amount of previously encoded bins to reach optimal values. Suppose the update of probability starts from the initial value ½ which is far from the optimal. To avoid a loss of compression for the first encoded bins, the present disclosure proposed to use only a short window size model for several bins in the beginning after initialization and then when the number of updates reaches the threshold, the model with a long window that may be initialized by the value from the model with a short window. The two models work together.

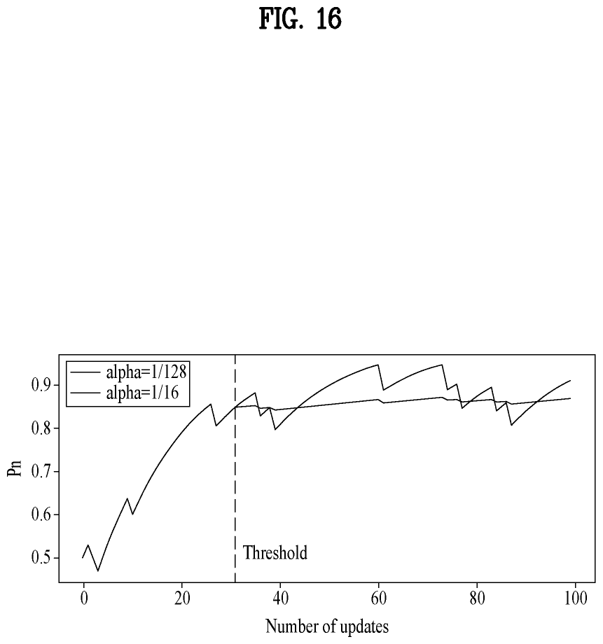

FIG. 16 illustrates probability estimation according to embodiments.

FIG. 16 illustrates probability estimation before and after a threshold depending on the parameter α.

After the counter reaches the threshold, increasing the counter may be stopped, and updating the second model may be started. That is why the same memory can be utilized for the counter and second model. Only one bit (stopper) is needed to indicate that the threshold is reached. After resetting of entropy coding, it is necessary to set P₀=Pᵢₙᵢₜ, P₁=Pᵢₙᵢₜ counter=0, and stopper=0.

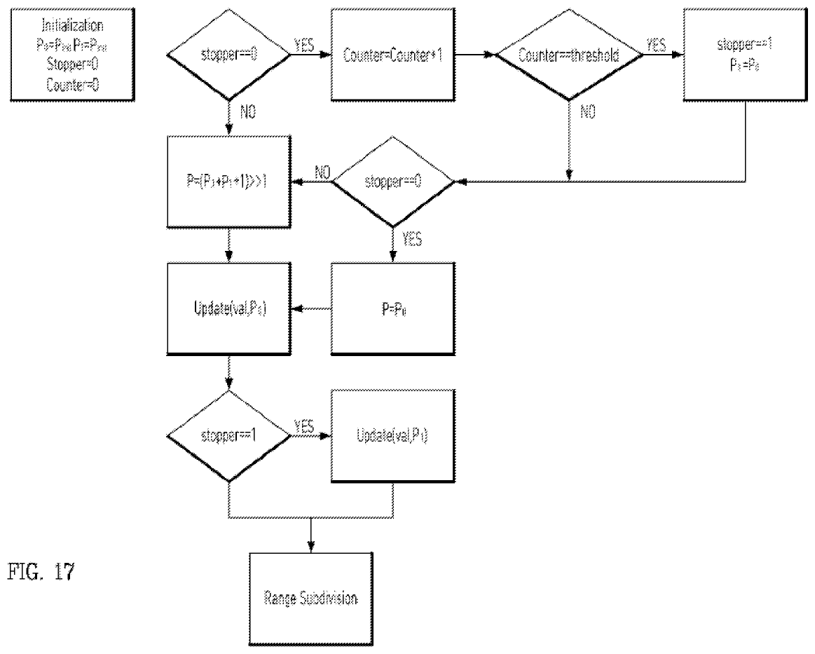

FIG. 17 illustrates a probability estimation method according to embodiments.

FIG. 17 is a flowchart of probability update.

If stopper=0, increase the counter by 1 and determine whether the counter has reached the threshold. If the counter has reached the threshold, stopper becomes 1, and P₁ becomes P₀. If the counter has not reached the threshold, determine whether stopper=0. If stopper=0, P becomes P₀. If stopper ≠0, P is set to the value obtained by shifting (P₀+P₁+1) by 1. Then, update P₀. If stopper=1, update P₁. Then, divide the range.

An update of each probability model may be performed using a constant α. In this case, it is better to choose α=1/2^{k} as multiplication may be substituted by arithmetic right shift (>>k). The right shift divides the number by 2^{k}, throwing out any remainder.

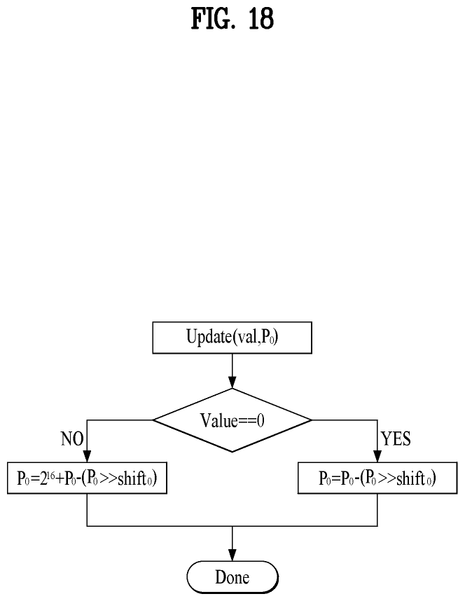

FIG. 18 illustrates a probability update method according to embodiments.

FIG. 18 is a flowchart of probability update for one model with a constant α=1/2^{k}.

If the alpha parameter depends on a probability lookup table, approximation is used

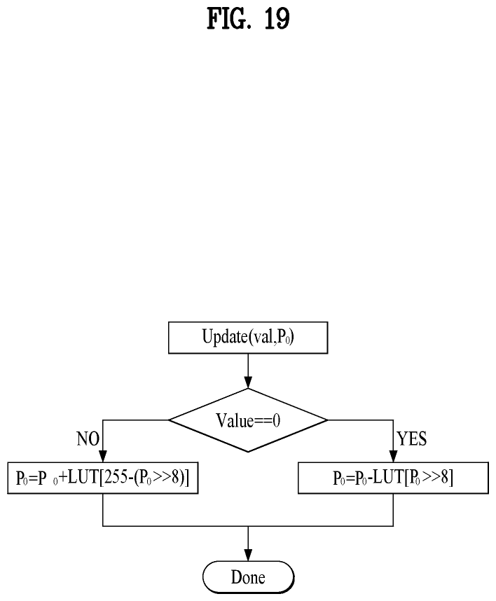

FIG. 19 illustrates a probability update method according to embodiments.

FIG. 19 is a flowchart of probability update for one model with parameter α that depends on probability.

Thus, a model with a two-estimator may allow for improving the accuracy of probability estimation.

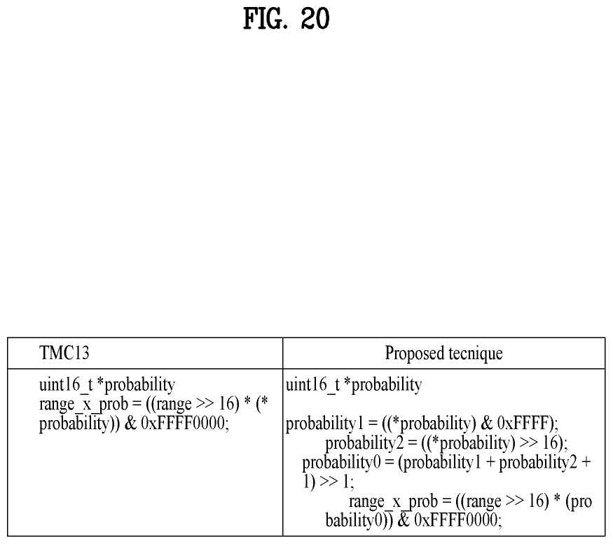

FIG. 20 illustrates syntax and semantics of probability in context bin decoding according to embodiments.

The proposed new coding scheme does not change any syntax. Main changes are included in probability estimation.

The first and second probabilities are calculated as probability 1=((*probability) & 0xFFFF) and probability2=((*probability)>>16), and the third probability probability0 is calculated therefrom as:

$$probability 0 = ( probability 1 + probability 2 + 1 ) >> 1.$$

Then, based on the third probability probability0, the range value of CABAC processing is set as:

$$range\_x \_prob = ( ( range >> 16 ) * ( probability 0 ) ) \& 0 \times FFFF 0.$$

A bin is a binary symbol (bit) of the binarized representation of a syntax element value.

In CABAC processing, regarding initialization, the arithmetic decoding engine and the contextual probability model (CPM) are initialized at the start of the following operations: occupancy_tree, occupancy_tree_level(depth) (if depth>OcctreeEntropyStreamDepth), prediction_tree, attribute_coeffs.

The variable AeReadBin is defined to specify a single arithmetic-coded bin read using the AeReadBin expression. Each evaluation reads a single bin parameterized by the name of the coded syntax element. A CPM identified by the expression Ctx is selected.

If the value of Ctx is not ‘bypass’ or ‘terminate’, the value of the decoded bin is determined for a single arithmetic coding bin using Ctx as the prob0 argument. The selected CPM is updated using the decoded bin value as the bin Val argument.

If the value of Ctx is ‘bypass’, the value of the decoded bin is determined as follows: If Bypass_stream_enabled for the arithmetic-coded bypass bin is 0, if Bypass_stream_enabled is 1, the expression ChunkNextBpBit (11.3.10) is evaluated.

If the value of Ctx is ‘terminate’, the arithmetic decoder is flushed.

Regarding the contextual probability models of CABAC processing, CPM is a 16-bit unsigned integer value modeling the probability of a zero bin. Values of 0, 2\hat{ }15, and 2\hat{ }16 indicate the probability of the zero bin as impossible, equiprobable and certain, respectively. Due to the operation of the context update process, the values of 0 and 2\hat{ }16 may never be obtained. The Contexts array containing the Contexts [ctxTbl][ctxIdx] element represents an individual adaptive CPM used in the CABAC parsing process.

When slice_entropy_continuation is 1, initialization shall be performed according to the parsing state restoration process. Otherwise (slice_entropy_continuation is 0), all CPMs shall be initialized to 2\hat{ }15.

Regarding “Update after each coded bin” in CABAC processing, after each bin is coded using an adaptive CPM, the modeled probability is updated. The parameter bin Val is the value of the coded bin, and the expression Ctx identifies the CPM used for arithmetic coding thereof. The update increases or decreases the modeled probability of a 0-value bin based on the known value of the coded bin, the upper 8 bits of the modeled probability, and the specified channel model.

Regarding “Selection” in CABAC processing, a CPM is selected for each bin of the coded syntax element as specified by the expression Ctx. CtxTbl and CtxIdx values are determined based on the entry for the syntax element. Entries limited to offset, prefix, or suffix are applied individually when selecting the CPM for the corresponding part of the binarized syntax element.

The arithmetic decoding engine is a context-adaptive binary arithmetic decoder that performs binary renormalization and produces binary outputs.

The arithmetic decoder is specified with the following state variables: IvlLow, which indicates the start of the 16-bit coding interval, IvlRange, which indicates the size of the 16-bit coding interval. IvlCode, the codeword within the interval [IvlLow, IvlLow+IvlRange−1], which is updated from the arithmetic-coded bitstream.

The arithmetic decoding state variables are initialized. 16 bits shall be read from the arithmetic-coded bitstream.

The next bit to be used as input to the arithmetic decoder is specified by the expression NextAeStreamBit.

Decoding is parameterized by the probability prob0 that the decoded binary symbol will be a value of 0. The decoded binary value bin Val is determined, and the state variables IvlRange and IvlCode are updated.

```
rangeTimesProb = IvlRange × prob0 >> 16
binVal = rangeTimeProb ≤ IvlCode − IvlLow
if (¬binVal)
  IvlRange = rangeTimesProb
else {
  IvlLow += rangeTimesProb
  IvlRange −= rangeTimesProb
}
```

The decoded binary value bin Val is determined, and the state variables IvlRange and IvlCode are updated.

Renormalization prevents loss of accuracy in the arithmetic decoding engine. Renormalization is applied as long as the size of the coding interval is smaller than or equal to ¼ of the full 16-bit available range. Each renormalization doubles the interval and reads a bit from the codeword.

The arithmetic decoder is flushed at the end of each occupancy tree entropy stream. Flushing involves repeatedly performing state renormalization until IvlRange exceeds 2\hat{ }14, then discarding bits from the arithmetic-coded bitstream until the bytes are aligned.

Geometry-based point cloud compression data represents volumetric encoding of point clouds composed of a sequence of point cloud frames. Each point cloud frame includes the number of points, their positions, and their attributes, which may vary from frame to frame.

Source point cloud data may be partitioned to multiple slices and may be encoded in a bitstream. A slice is a set of points that may be encoded or decoded independently. Geometry and attribute information about each slice may be encoded or decoded independently. A tile is a group of slices with bounding box information. The bounding box information of each tile is specified in tile inventory. A tile may overlap another tile in the bounding box. Each slice contains an index that identifies the tile to which it belongs. A G-PCC bitstream may be composed of parameter sets (e.g., sequence parameter set, geometry parameter set, attribute parameter set), geometry slices, or attribute slices.

The point cloud data transmission method/device according to the embodiments (i.e., the transmission device 10000, the point cloud video encoder 10002, the transmitter 10003 in FIG. 1, the acquisition 20000/encoding 20001/transmission 20002 in FIG. 2, the encoder in FIG. 3, the transmission device in FIG. 8, the devices in FIG. 10, the probability update in FIG. 11; the entropy coding in FIG. 12; the probability estimation in FIG. 13; the probability application in FIG. 14; probability estimation in FIGS. 15 to 20, the transmission device (encoder) in FIG. 24, the context bin encoding in FIG. 27, the transmission method in FIG. 28) encodes point cloud data, generates related parameters, and transmits a bitstream containing the point cloud data and parameter sets.

The point cloud data reception method/device according to the embodiments (e.g., the transmission device 10000, the point cloud video encoder 10002, the transmitter 10003 in FIG. 1, the acquisition 20000/encoding 20001/transmission 20002 in FIG. 2, the encoder in FIG. 3, the transmission device in FIG. 8, the devices in FIG. 10, the probability update in FIG. 11, the entropy coding in FIG. 12, the probability estimation in FIG. 13, the probability application in FIG. 14, the probability estimation in FIGS. 15 to 20, the reception device (decoder) in FIG. 25, the context bin decoding in FIG. 26, the reception method in FIG. 29) receives the bitstream and decodes the point cloud data based on the parameter sets.

Hereinafter, parameter sets contained in the bitstream are described with reference to FIGS. 21 to 23.

FIG. 21 illustrates a sequence parameter set (SPS) in a bitstream according to embodiments.

main_profile_compatibility_flag equal to 1 specifies that the bitstream conforms to the Main profile. main_profile_compatibility_flag equal to 0 specifies that the bitstream conforms to a profile other than the Main profile.

unique_point_positions_constraint_flag equal to 1 indicates that in each point cloud frame that refers to the current SPS, all output points have unique positions.

unique_point_positions_constraint_flag equal to 0 indicates that in any point cloud frame that refers to the current SPS, two or more output points may have the same position.

level_idc indicates a level to which the bitstream conforms.

sps_seq_parameter_set_id provides an identifier for the SPS for reference by other syntax elements.

sps_bounding_box_present_flag equal to 1 indicates that a bounding box. sps_bounding_box_present_flag equal to 0 indicates that the size of the bounding box is undefined.

sps_bounding_box_offset_x, sps_bounding_box_offset_y, and

sps_bounding_box_offset_z indicate quantized x, y, and z offsets of the source bounding box in Cartesian coordinates.

sps_bounding_box_offset_log2_scale indicates the scaling factor to scale the quantized x, y, and z source bounding box offsets.

sps_bounding_box_size_width, sps_bounding_box_size_height, and

sps_bounding_box_size_depth indicate the width, height, and depth of the source bounding box in Cartesian coordinates.

sps_source_scale_factor_numerator_minus1+1 indicates the scale factor numerator of the source point cloud.

sps_source_scale_factor_denominator_minus1+1 indicates the scale factor denominator of the source point cloud.

sps_num_attribute_sets indicates the number of coded attributes in the bitstream. The value of sps_num_attribute_sets shall be in the range of 0 to 63.

attribute_dimension_minus1[i] plus 1 specifies the number of components of the i-th attribute.

attribute_instance_id[i] specifies the instance ID for the i-th attribute.

attribute_bitdepth_minus1[i] plus 1 specifies the bitdepth for the first component of the i-th attribute signal.

attribute_secondary_bitdepth_minus1[i] plus 1 specifies the bitdepth for the secondary component of the i-th attribute signal.

attribute_cicp_colour primaries[i] indicates the chromaticity coordinates of the color attribute source primaries of the i-th attribute.

attribute_cicp_transfer_characteristics[i] either indicates the reference opto-electronic transfer characteristic function of the color attribute as a function of a source input linear optical intensity Lc with a nominal real-valued range of 0 to 1 or indicates the inverse of the reference electro-optical transfer characteristic function as a function of an output linear optical intensity Lo with a nominal real-valued range of 0 to 1.

attribute_cicp_matrix_coeffs[i] describes the matrix coefficients used in deriving luma and chroma signals from the green, blue, and red, or Y, Z, and X primaries.

attribute_cicp_video_full_range_flag[i] indicates the black level and range of the luma and chroma signals as derived from E′Y, E′PB, and E′PR or E′R, E′G, and E′B real-valued component signals.

known_attribute_label_flag[i] equal to 1 specifies that know_attribute_label is signaled for the i-th attribute. known_attribute_label_flag[i] equal to 0 specifies that attribute_label_four_bytes is signaled for the i-th attribute.

known_attribute_label[i] equal to 0 specifies that the attribute is color. known_attribute_label[i] equal to 1 specifies that the attribute is reflectance. known_attribute_label[i] equal to 2 specifies that the attribute is frame index.

attribute_label_four_bytes[i] indicates the known attribute type with the 4 bytes code. Table describes a list of attributes and their relationship with attribute_label_four_bytes[i]. Values of attribute_label_four_bytes[i] indicate the attribute types as follows: 0 indicates colour, 1 indicates reflectance, 2 indicates frame index, 3 indicates material ID, 4 indicates transparency, 5 indicates normals, 6 to 255 are reserved, and 256 to 0xffffffff indicate Unspecified.

log2_max_frame_idx+1 specifies the number of bits used to signal the syntax variable frame_idx.

axis_coding_order specifies the correspondence between the X, Y, and Z output axis labels and the three position components of all points in the reconstructed point cloud RecPic[pointIdx][axis] with axis=0 . . . 2.

axis_coding_order specifies the values of X, Y, and Z as follows: 0 specifies 2, 1, and 0; 1 specifies 0, 1, and 2; 2 specifies 0, 2, and 1; 3 specifies 2, 0, and 1; 4 specifies 2, 1, and 0; 5 specifies 1, 2, and 0; 6 specifies 1, 0, and 2; and 7 specifies 0, 1, and 2.

sps_bypass_stream_enabled_flag equal to 1 specifies that the bypass coding mode may be used in reading the bitstream. sps_bypass_stream_enabled_flag equal to 0 specifies that the bypass coding mode is not used in reading the bitstream.

sps_extension_flag equal to 0 specifies that the syntax element sps_extension_data_flag is not present in the SPS syntax structure. sps_extension_flag shall be equal to 0 in bitstreams conforming to this version of this specification.

sps_extension_data_flag may have any value. Its presence and value do not affect decoder conformance to profiles.

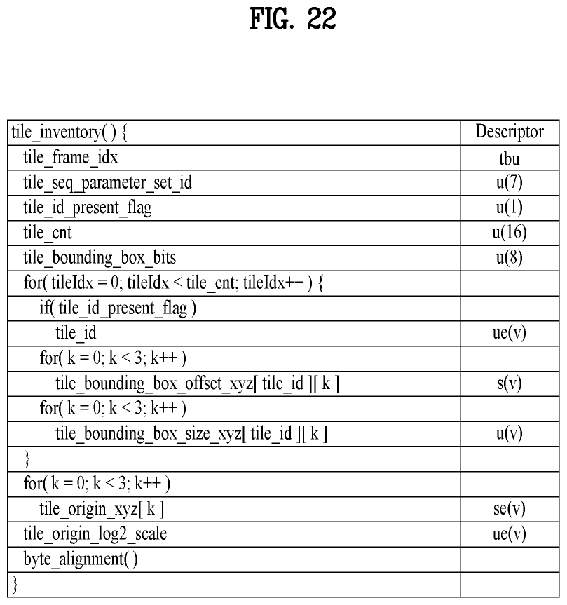

FIG. 22 illustrates a tile parameter set (TPS) in a bitstream according to embodiments.

tile_frame_idx contains an identifying number that may be used to identify the purpose of the tile inventory.

tile_seq_parameter_set_id specifies the value of sps_seq_parameter_set_id for the active SPS.

tile_id_present_flag equal to 1 specifies that tiles are identified according to the value of the syntax element tile_id. tile_id_present_flag equal to 0 specifies that tiles are identified according to their positions in the tile inventory.

tile_cnt specifies the number of tile bounding boxes present in the tile inventory.

tile_bounding_box_bits specifies the bitdepth to represent the bounding box information for the tile inventory.

tile_id identifies a particular tile within the tile_inventory. When not present, the value of tile id is inferred to be the index of the tile within the tile inventory as given by the loop variable tileIdx. It is a requirement of bitstream conformance that all values of tile_id are unique within a tile inventory.

tile_bounding_box_offset_xyz[tileId][k] and tile_bounding_box_size_xyz[tileId][k] specify a bounding box encompassing slices identified by gsh_tile_id equal to tileId.tile_bounding_box_offset_xyz[tileId][k]. The (x, y, z) origin coordinates of the tile bounding box relative to TileOrigin[k].tile_bounding_box_size_xyz[tileId][k] is the k-th component of the tile bounding box width, height, and depth, respectively.

tile_origin_xyz[k] specifies the k-th component of the tile origin in Cartesian coordinates. The value of tile_origin_xyz[k] is equal to sps_bounding_box_offset[k].

tile_origin_log2_scale specifies a scaling factor to scale components of tile_origin_xyz. The value of tile_origin_log2_scale should be equal to sps_bounding_box_offset_log2_scale. The array TileOrigin, with elements TileOrigin[k] for k=0 . . . 2, is derived as follows:

$$TileOrigin [ k ] = tile\_origin \_xyz [ k ] << \text{tile\_origin\_log2\_scale.}$$

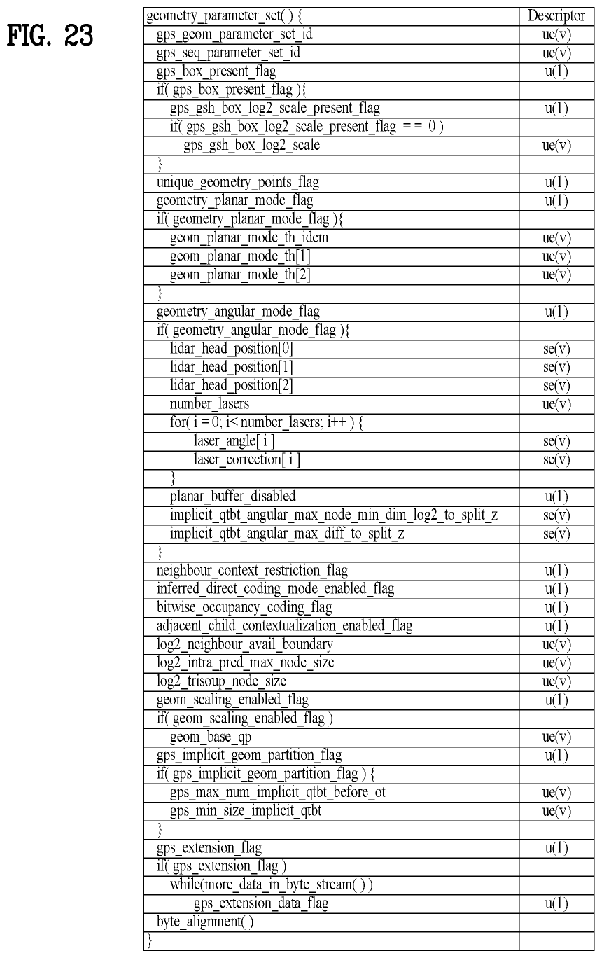

FIG. 23 illustrates a geometry parameter set (GPS) in a bitstream according to embodiments.

gps_geom_parameter_set_id provides an identifier for the GPS for reference by other syntax elements.

gps_seq_parameter_set_id specifies the value of sps_seq_parameter_set_id for the active SPS.

gps_box_present_flag equal to 1 specifies that additional bounding box information is provided in a geometry header that references the current GPS. gps_bounding_box_present_flag equal to 0 specifies that additional bounding box information is not signaled in the geometry header.

gps_gsh_box_log2_scale_present_flag equal to 1 specifies that gsh_box_log2_scale is signaled in each geometry slice header that references the current GPS.

gps_gsh_box_log2_scale_present_flag equal to 0 specifies that gsh_box_log2_scale is not signaled in each geometry slice header and a common scale for all slices is signaled in gps_gsh_box_log2_scale of current GPS.

gps_gsh_box_log2_scale indicates the common scale factor of the bounding box origin for all slices that reference the current GPS.

unique_geometry_points_flag equal to 1 indicates that, in all slices that refer to the current GPS, all output points have unique positions within a slice.

unique_geometry_points_flag equal to 0 indicates that, in all slices that refer to the current GPS, two or more of the output points may have same position within a slice.

geometry_planar_mode_flag equal to 1 indicates that the planar coding mode is activated.

geometry_planar_mode_flag equal to 0 indicates that the planar coding mode is not activated.

geom_planar_mode_th_idcm specifies the value of the threshold of activation for the direct coding mode. geom_planar_mode_th_idcm is an integer in the range of 0 to 127.

geom_planar_mode_th[i], for i in the range 0 . . . 2, specifies the value of the threshold of activation for the planar coding mode along the i-th most probable direction for the planar coding mode to be efficient. geom_planar_mode_th[i] is an integer in the range of 0 to 127.

geometry_angular_mode_flag equal to 1 indicates that the angular coding mode is activated. geometry_angular_mode_flag equal to 0 indicates that the angular coding mode is not activated.

lidar_head_position specifies the (X, Y, Z) coordinates of the lidar head in the coordinate system with the internal axes.

number_lasers specifies the number of lasers used for the angular coding mode.

laser_angle[i], for i in the range of 1 . . . number_lasers, specifies the tangent of the elevation angle of the i-th laser relative to the horizontal plane defined by the 0-th and first internal axes.

laser_correction[i] specifies the correction, along the second internal axis, of the i-th laser position relative to the lidar_head_position [2].

planar_buffer_disabled equal to 1 indicates that tracking the closest nodes using a buffer is not used in process of coding the planar mode flag and the plane position in the planar mode. planar_buffer_disabled equal to 0 indicates that tracking the closest nodes using a buffer is used. When not present, planar_buffer_disabled is inferred to be 0.

implicit_qtbt_angular_max_node_min_dim_log2_to_split_z specifies the log2 value of a node size below which horizontal split of nodes is preferred over vertical split.

implicit_qtbt_angular_max_diff_to_split_z specifies the log2 value of the maximum vertical over horizontal node size ratio allowed for a node. When not present, implicit_qtbt_angular_max_node_min_dim_log2_to_split_z is inferred to be 0.

neighbour_context_restriction_flagequal to 0 indicates that geometry node occupancy of the current node is coded with the contexts determined from neighboring nodes which are located inside the parent node of the current node. neighbour_context_restriction_flag equal to 0 indicates that geometry node occupancy of the current node is coded with the contexts determined from neighboring nodes which are located inside or outside the parent node of the current node.

inferred_direct_coding_mode_enabled_flag equal to 1 indicates that direct_mode_flag may be present in the geometry node syntax. inferred_direct_coding_mode_enabled_flag equal to 0 indicates that direct_mode_flag is not present in the geometry node syntax.

bitwise_occupancy_coding_flag equal to 1 indicates that geometry node occupancy is encoded using bitwise contextualization of the syntax element ocupancy_map. bitwise_occupancy_coding_flag equal to 0 indicates that geometry node occupancy is encoded using the pre-encoded syntax element occupancy_byte.

adjacent_child_contextualization_enabled_flag equal to 1 indicates that the adjacent children of neighboring octree nodes are used for bitwise occupancy contextualization. adjacent_child_contextualization_enabled_flag equal to 0 indicates that the children of neighboring octree nodes are not used for the occupancy contextualization.

log2_neighbour_avail_boundary specifies the variable NeighbAvailabilityMask. When neighbour_context_restriction_flag is equal to 1, NeighbAvailabilityMask is set equal to 1. Otherwise, neighbour_context_restriction_flag is equal to 0.

log2_intra_pred_max_node_size specifies the octree node size eligible for occupancy intra prediction.

log2_trisoup_node_size specifies the variable TrisoupNodeSize as the size of the triangle nodes

geom_scaling_enabled_flag equal to 1 specifies that a scaling process for geometry positions is invoked during the geometry slice decoding process. geom_scaling_enabled_flag equal to 0 specifies that geometry positions do not require scaling.

geom_base_qp specifies the base value of the geometry position quantization parameter.

gps_implicit_geom_partition_flag equal to 1 specifies that the implicit geometry partition is enabled for the sequence or slice. gps_implicit_geom_partition_flag equal to 0 specifies that the implicit geometry partition is disabled for the sequence or slice. If gps_implicit_geom_partition_flag is equal to 1, gps_max_num_implicit_qtbt_before_otandgps_min_size_implicit_qtbt is signaled.

gps_max_num_implicit_qtbt_before_ot specifies the maximal number of implicit QT and BT partitions before OT partitions.

gps_min_size_implicit_qtbt specifies the minimal size of implicit QT and BT partitions.

gps_extension_flag equal to 0 specifies that the syntax element gps_extension_data_flag is present in the GPS syntax structure.

gps_extension_data_flag may have any value. Its presence and value do not affect decoder conformance to profiles specified in this version of this specification.

FIG. 24 illustrates a point cloud data transmission device according to embodiments.

FIG. 24 represents the transmission device 10000, the encoder 10002 in FIG. 1, and the encoders in FIGS. 3 and 8.

Each component in FIG. 24 corresponds to hardware, software, a processor, and/or a combination thereof.

For details of the components in FIG. 24, refer to the descriptions provided above.

A data input unit may receive values of parameters related to geometry data, attribute data, and point cloud data.

A coordinate transformer may transform coordinates representing positions of points, which are geometry data, into coordinates suitable for encoding.

A geometry information transform quantization processor may quantize the geometry data based on quantization parameters.

The spatial partitioner may partition the space containing points, which are geometry data.

A geometry information encoder encodes the geometry data.

A voxelization processor may voxelize the space containing points, which are geometry data, into voxels.

The geometry information encoder may encode geometry data based on an octree (or occupancy tree), prediction tree, trisoup, etc.

An occupancy tree generator may present points, which are geometry data, in an occupancy tree. A prediction tree generator may generate a prediction tree that connects parent and child nodes based on similarity between points. A trisoup generator may present the point cloud data in a trisoup form.

After the geometry data is encoded, a geometry position reconstructor reconstructs the encoded geometry data and provides the same to an attribute information encoder.

A geometry information entropy encoder performs arithmetic encoding on the geometry data or residual values resulting from predicted values of the geometry data.

The attribute information encoder encodes the attribute data.

A color transform processor transforms the color scheme of color, which is attribute data, into a scheme suitable for encoding.

As described above, the attribute information encoder expresses the attribute data using LoD, a prediction tree, etc., and encodes the same using the prediction, lifting, or RAHT method.

An attribute information entropy encoder performs arithmetic encoding on the attribute data or residual values resulting from the predicted values of the attribute data.

FIG. 25 illustrates a point cloud data reception device according to embodiments.

FIG. 25 represents the reception device 10004, the decoder 1006 in FIG. 1, and the decoders in FIGS. 7 and 9.

Each component in FIG. 25 corresponds to hardware, software, a processor, and/or a combination thereof.

The device in FIG. 25 may perform a reverse process of the operations in FIG. 24.

For details of the components in FIG. 25, refer to the descriptions provided above.

A geometry information decoder receives a geometry information bitstream containing geometry data in a bitstream.

A geometry information entropy decoder performs arithmetic decoding on the geometry data.

Depending on the geometry coding type used by the encoder, the following operations are performed. When the type is octree-based coding, an occupancy tree reconstructor reconstructs the geometry data in the form of an occupancy tree. When the typs is prediction tree-based coding, a prediction tree reconstructor reconstructs the geometry data in the form of a prediction tree.

A geometry position reconstructor reconstructs the positions of points, which are geometry data, and delivers the reconstructed positions to an attribute information decoder.

In the case of octree-based coding, a geometry information predictor predicts the geometry data based on the occupancy tree structure and adds the predicted values and residual values to generate the geometry data. In the case of prediction tree-based coding, the predictor predicts the geometry data based on the prediction tree structure and adds the predicted values and residual values to generate the geometry data.

A geometry information inverse quantization processor inversely quantizes the geometry data based on quantization parameters.

A coordinate inverse transformer performs inversely transforms the coordinates of the geometry data.

The attribute information decoder receives an attribute information bitstream containing attribute data in a bitstream.

An attribute residual information entropy decoder performs arithmetic decoding on the received attribute data.

As described above, the attribute information decoder decodes the attribute data using prediction/lifting/RAHT methods based on the LoD, prediction tree, etc.

An attribute information inverse quantization processor inversely quantizes the attribute data.

A color inverse transform processor inversely transforms the color of the attribute data.

FIG. 26 illustrates a method of decoding context bins for two probability modes according to embodiments.

FIG. 26 illustrates a context-based decoding method for arithmetic decoding in a point cloud data reception method.

By adding a first probability P0, a second probability P1, and 1, and right-shifting the sum by 1, a probability P is generated.

The range x prob for context bin probability estimation is generated by right-shifting the range value by 16, multiplying the shifted range by the probability P, and performing the AND operation with 0xFFFF0000.

The first probability P0 and second probability P1 are updated and renormalized by setting the variable val to 1.

FIG. 27 illustrates a method of encoding context bins for two probability modes according to embodiments.

FIG. 27 illustrates a context-based encoding method for arithmetic encoding in a point cloud data transmission method.

By adding a first probability P0, a second probability P1, and 1, and right-shifting the sum by 1, a probability P is generated.

The range x prob for context bin probability estimation is generated by multiplying the range value by the probability P and right-shifting the result by 16.

The first probability P0 and second probability P1 are updated and renormalized.

FIG. 28 illustrates a method of transmitting point cloud data according to embodiments.

The point cloud data transmission method/device according to the embodiments (i.e., the transmission device 10000, the point cloud video encoder 10002, the transmitter 10003 in FIG. 1, the acquisition 20000/encoding 20001/transmission 20002 in FIG. 2, the encoder in FIG. 3, the transmission device in FIG. 8, the devices in FIG. 10, the probability update in FIG. 11; the entropy coding in FIG. 12; the probability estimation in FIG. 13; the probability application in FIG. 14; probability estimation in FIGS. 15 to 20, the bitstream and parameter generation in FIGS. 21 to 23, the transmission device (encoder) in FIG. 24, and the context bin encoding in FIG. 27) encodes and transmits point cloud data as shown in FIG. 28.

S2800: the point cloud data transmission method according to the embodiments may include encoding point cloud data.

S2801: the point cloud data transmission method according to the embodiments may further include transmitting a bitstream containing the point cloud data.

Referring to FIG. 25, operation S2800 of encoding the point cloud data may include encoding geometry data of the point cloud data and encoding attribute data of the point cloud data. The encoding of the geometry data may include performing context-based arithmetic encoding on the geometry data, and the encoding of the attribute data may include performing context-based arithmetic encoding on the attribute data.

Referring to FIGS. 20 and 27, the context-based arithmetic encoding may include generating, based on a first probability (probability1) and a second probability (probability2), a third probability (probability0) for estimation of a context bin for a symbol, generating a range (range_x_prob) for the estimation of the context bin for the symbol based on the third probability, updating the first probability, and updating the second probability.

In addition, the first probability and the second probability may each be generated based on an initial value, and the third probability may be generated based on a sum of the first probability and the second probability and a shift of the sum. The range may be generated by multiplying the third probability by a first range.

Here, the third probability may be generated by non-linearly smoothing two estimators including the first probability and the second probability.

The transmission method of FIG. 28 is performed by the transmission device in FIG. 1 and the like. The point cloud data transmission device may include an encoder configured to encode point cloud data; a transmitter configured to transmit a bitstream containing the point cloud data. The transmission device may be composed of a memory storing instructions including encoding operations and a processor connected to the memory. The instructions including the encoding operations may be configured to cause a processor to encode the point cloud data.

FIG. 29 illustrates a method of receiving point cloud data according to embodiments.

The point cloud data reception method/device according to the embodiments (e.g., the transmission device 10000, the point cloud video encoder 10002, the transmitter 10003 in FIG. 1, the acquisition 20000/encoding 20001/transmission 20002 in FIG. 2, the encoder in FIG. 3, the transmission device in FIG. 8, the devices in FIG. 10, the probability update in FIG. 11, the entropy coding in FIG. 12, the probability estimation in FIG. 13, the probability application in FIG. 14, the probability estimation in FIGS. 15 to 20, the bitstream and parameter parsing in FIGS. 21 to 23, the reception device (decoder) in FIG. 25, and the context bin decoding in FIG. 26) receives and decodes point cloud data as shown in FIG. 29.

S2900: the point cloud data reception method according to the embodiments may include receiving a bitstream containing point cloud data.

S2901: the point cloud data reception method according to the embodiments may further include decoding the point cloud data.

Operation S2901 of decoding the point cloud data may include decoding geometry data of the point cloud data and decoding attribute data of the point cloud data. The decoding of the geometry data may include performing context-based arithmetic decoding on the geometry data, and the decoding of the attribute data may include performing context-based arithmetic decoding on the attribute data.

Referring to FIGS. 20 and 27, the context-based arithmetic decoding may include generating, based on a first probability (probability1) and a second probability (probability2), a third probability (probability0) for estimation of a context bin for a symbol, generating a range (range_x_prob) for the estimation of the context bin for the symbol based on the third probability, updating the first probability, and updating the second probability.

Herein, referring to FIG. 20, the first probability and the second probability may each be generated based on an initial value (probability), and the third probability may be generated based on a sum of the first probability and the second probability and a shift of the sum. The range (range_x_prob) may be generated by multiplying the third probability by a first range.

The third probability may be generated by non-linearly smoothing two estimators including the first probability and the second probability.

The reception method in FIG. 29 is performed by the reception device in FIG. 1 and the like. The point cloud data reception device may include a receiver configured to receive a bitstream containing point cloud data; and a decoder configured to decode the point cloud data. The reception device may be composed of a memory storing instructions including decoding operations and a processor connected to the memory. The instructions including the decoding operations may be configured to cause a processor to decode the point cloud data.

Through the embodiments, the compression of overhead related to context modeling may be improved. The size of the bitstream may be reduced. Although probability estimation is performed using two models, both models are independent and calculation may be performed in parallel. Decoder time is almost the same and even may be less due to the smaller bitsize. Using two probabilities estimators may allow for improving accuracy taking into account the statistical and dynamical properties of the source. It may quickly react to changes in statistics. It is applied for maintaining robust and precise probability estimation for a wide class of encoding data. The proposed algorithm is effective for all parts of point cloud data for the geometry and attributes. This algorithm may be applied for lossy compression and lossless compression. It would work equally well for low and high quantization parameters (QPs). Embodiments are very effective for binary coding. They may be also applied for multi-symbol entropy coding where cumulative probabilities need to be estimated. The proposed algorithm has low complexity, a hardware and software-friendly design, and low latency. It is not contradictory with other entropy coding modes such as bypass modes, V2V, Rice and Golomb codes. It is also friendly for well-known encoder-only techniques such as RDOQ (Rate Distortion Optimization Quantization), BRC (Bit Rate Control), etc.

The embodiments have been described in terms of a method and/or a device, and the description of the method and the description of the device may be applied complementary to each other.

Although the accompanying drawings have been described separately for simplicity, it is possible to design new embodiments by combining the embodiments illustrated in the respective drawings. Designing a recording medium readable by a computer on which programs for executing the above-described embodiments are recorded as needed by those skilled in the art also falls within the scope of the appended claims and their equivalents. The devices and methods according to embodiments may not be limited by the configurations and methods of the embodiments described above. Various modifications can be made to the embodiments by selectively combining all or some of the embodiments. Although preferred embodiments have been described with reference to the drawings, those skilled in the art will appreciate that various modifications and variations may be made in the embodiments without departing from the spirit or scope of the disclosure described in the appended claims. Such modifications are not to be understood individually from the technical idea or perspective of the embodiments.

Various elements of the devices of the embodiments may be implemented by hardware, software, firmware, or a combination thereof. Various elements in the embodiments may be implemented by a single chip, for example, a single hardware circuit. According to embodiments, the components according to the embodiments may be implemented as separate chips, respectively. According to embodiments, at least one or more of the components of the device according to the embodiments may include one or more processors capable of executing one or more programs. The one or more programs may perform any one or more of the operations/methods according to the embodiments or include instructions for performing the same. Executable instructions for performing the method/operations of the device according to the embodiments may be stored in a non-transitory CRM or other computer program products configured to be executed by one or more processors, or may be stored in a transitory CRM or other computer program products configured to be executed by one or more processors. In addition, the memory according to the embodiments may be used as a concept covering not only volatile memories (e.g., RAM) but also nonvolatile memories, flash memories, and PROMs. In addition, it may also be implemented in the form of a carrier wave, such as transmission over the Internet. In addition, the processor-readable recording medium may be distributed to computer systems connected over a network such that the processor-readable code may be stored and executed in a distributed fashion.

In the present disclosure, “/” and “,” should be interpreted as indicating “and/or.” For instance, the expression “A/B” may mean “A and/or B.” Further, “A, B” may mean “A and/or B.” Further, “A/B/C” may mean “at least one of A, B, and/or C.” Also, “A/B/C” may mean “at least one of A, B, and/or C.” Further, in this specification, the term “or” should be interpreted as indicating “and/or.” For instance, the expression “A or B” may mean 1) only A, 2) only B, or 3) both A and B. In other words, the term “or” used in this document should be interpreted as indicating “additionally or alternatively.”

Terms such as first and second may be used to describe various elements of the embodiments. However, various components according to the embodiments should not be limited by the above terms. These terms are only used to distinguish one element from another. For example, a first user input signal may be referred to as a second user input signal. Similarly, the second user input signal may be referred to as a first user input signal. Use of these terms should be construed as not departing from the scope of the various embodiments. The first user input signal and the second user input signal are both user input signals, but do not mean the same user input signals unless context clearly dictates otherwise.

The terms used to describe the embodiments are used for the purpose of describing specific embodiments, and are not intended to limit the embodiments. As used in the description of the embodiments and in the claims, the singular forms “a”, “an”, and “the” include plural referents unless the context clearly dictates otherwise. The expression “and/or” is used to include all possible combinations of terms. The terms such as “includes” or “has” are intended to indicate existence of figures, numbers, steps, elements, and/or components and should be understood as not precluding possibility of existence of additional existence of figures, numbers, steps, elements, and/or components. As used herein, conditional expressions such as “if” and “when” are not limited to an optional case and are intended to perform the related operation or interpret the related definition according to a specific condition when the specific condition is satisfied.

Operations according to the embodiments described in this specification may be performed by a transmission/reception device including a memory and/or a processor according to embodiments. The memory may store programs for processing/controlling the operations according to the embodiments, and the processor may control various operations described in this specification. The processor may be referred to as a controller or the like. In embodiments, operations may be performed by firmware, software, and/or combinations thereof. The firmware, software, and/or combinations thereof may be stored in the processor or the memory.

The operations according to the above-described embodiments may be performed by the transmission device and/or the reception device according to the embodiments. The transmission/reception device may include a transmitter/receiver configured to transmit and receive media data, a memory configured to store instructions (program code, algorithms, flowcharts and/or data) for the processes according to the embodiments, and a processor configured to control the operations of the transmission/reception device.

The processor may be referred to as a controller or the like, and may correspond to, for example, hardware, software, and/or a combination thereof. The operations according to the above-described embodiments may be performed by the processor. In addition, the processor may be implemented as an encoder/decoder for the operations of the above-described embodiments.

### MODE FOR DISCLOSURE

As described above, related details have been described in the best mode for carrying out the embodiments.

### INDUSTRIAL APPLICABILITY

As described above, the embodiments are fully or partially applicable to a point cloud data transmission/reception device and system.

Those skilled in the art may change or modify the embodiments in various ways within the scope of the embodiments.

Embodiments may include variations/modifications within the scope of the claims and their equivalents.

1. A method of transmitting point cloud data, the method comprising:
encoding point cloud data; and
transmitting a bitstream containing the point cloud data.

2. The method of claim 1, wherein the encoding of the point cloud data comprises:
encoding geometry data of the point cloud data; and
encoding attribute data of the point cloud data,
wherein the encoding of the geometry data comprises:
performing context-based arithmetic encoding on the geometry data, and
wherein the encoding of the attribute data comprises:
performing context-based arithmetic encoding on the attribute data.

3. The method of claim 2, wherein the context-based arithmetic encoding comprises:
generating, based on a first probability and a second probability, a third probability for estimation of a context bin for a symbol;
generating a range for the estimation of the context bin for the symbol based on the third probability;
updating the first probability; and
updating the second probability.

4. The method of claim 3, wherein the first probability and the second probability are each generated based on an initial value,
wherein the third probability is generated based on a sum of the first probability and the second probability and a shift of the sum, and
wherein the range is generated by multiplying the third probability by a first range.

5. The method of claim 3, wherein the third probability is generated by non-linearly smoothing two estimators including the first probability and the second probability.

6. A device for transmitting point cloud data, comprising:
an encoder configured to encode point cloud data; and
a transmitter configured to transmit a bitstream containing the point cloud data.

7. A method of receiving point cloud data, the method comprising:
receiving a bitstream containing point cloud data; and
decoding the point cloud data.

8. The method of claim 7, wherein the decoding of the point cloud data comprises:
decoding geometry data of the point cloud data; and
decoding attribute data of the point cloud data,
wherein the decoding of the geometry data comprises:
performing context-based arithmetic decoding on the geometry data, and
wherein the decoding of the attribute data comprises:
performing context-based arithmetic decoding on the attribute data.

9. The method of claim 8, wherein the context-based arithmetic decoding comprises:
generating, based on a first probability and a second probability, a third probability for estimation of a context bin for a symbol;
generating a range for the estimation of the context bin for the symbol based on the third probability;
updating the first probability; and
updating the second probability.

10. The method of claim 9, wherein the first probability and the second probability are each generated based on an initial value,
wherein the third probability is generated based on a sum of the first probability and the second probability and a shift of the sum, and
wherein the range is generated by multiplying the third probability by a first range.

11. The method of claim 9, wherein the third probability is generated by non-linearly smoothing two estimators including the first probability and the second probability.

12. A device for receiving point cloud data reception, comprising:
a receiver configured to receive a bitstream containing point cloud data; and
a decoder configured to decode the point cloud data.
